(19) United States
(12) Patent Application Publication
(10) Pub. No.: US 2002/0155196 A1
(43) Pub. Date: Oct. 24, 2002

(54) Edible cookie supports for comestibles with optional, edible mess guards and drip guards

(76) Inventor: Alice Mary O. Kiely, Yorktown Heights, NY (US)

Correspondence Address: ALICE O. KIELY, 71 STONEWALL COURT, YORKTOWN HEIGHTS, NY, 10598-1819, US

(21) Appl. No.: 10/163,209

(22) Filed: Jun. 5, 2002

Related U.S. Application Data
(62) Division of application No. 09/641,410, filed on Aug. 18, 2000.

(51) Int. Cl. A23L 1/00

(52) U.S. Cl. 426/89

(57) ABSTRACT

A supported comestible comprises a frozen comestible (84), or a non-frozen comestible (102), that is supported by an edible support (60, 62, 64, 68, 70, 72, 74, 96, 98, 116). The edible support has sufficient surface area inside the comestible (84, 102) to support the comestible. The edible support has sufficient surface area outside the comestible to provide a utilitarian support for the comestible. Protective, edible mess guards (76, 78), for the hands and fingers, protective, edible drip guards (80), freestanding edible supports (98), edible moisture-proof barriers/coatings and sealants (86), edible supported working models, multi-ingredient supports, mini and large size confections, comestible kits, protective packaging (112), stick alignment device (80, 118), and an “all in one” mold and packaging apparatus for frozen confections (120) are also provided.

### BACKGROUND—FIELD OF INVENTION

This is a divisional of application Ser. No. 09/641,410 filed on Aug. 18, 2000, pending.

### BACKGROUND—DESCRIPTION OF PRIOR ART

Many ice cream pop sticks are made of wood, which has several drawbacks. They can cause a splinter in the mouth or on the tongue, especially if a child begins to chew on the stick, as young children tend to do if the ice cream pop stick is not taken away from them right away by a responsible person. A piece of wood is not natural to the mouth, like food is, nor does it have any protective value of being in the mouth, like a mouth guard for sports.

Wooden ice cream pop sticks can cause even more injury if a playing child should happen to fall with one in their hand or mouth. Many parents and ice cream trucks serve ice cream pops outside where any messes incurred do not take a toll on the furnishings. Outside, active children are more susceptible to running and playing while simultaneously enjoying their confection. If a child runs and falls with a wooden ice cream pop stick in their hand or mouth there can be disastrous results, possibly some which require major surgery, and the use of anesthesia. These injuries may involve the upper palate, sinus cavities, throat, eyes, and other areas. These unfortunate accidents can also happen inside, in close quarters.

Wooden ice cream pop sticks add to the cost of the ice cream pop but do not add to the flavor of the frozen confection in any way.

Currently, a person eating an ice cream pop has to eat around the wooden stick and hope that the rest of the ice cream does not fall off the stick. Young children are not adept at eating an ice cream pop without a considerable probability of the confection falling off the stick. Children are distraught when their confection accidently falls off the stick. A replacement by the child's care giver doubles the cost.

A frozen ice cream pop is a well loved treat of many people but it is usually eaten rather quickly because it is so good. But because it is eaten so quickly and melts so quickly in the mouth, children feel somewhat disappointed when it is gone. When a child finishes eating the frozen confection, they have the feeling that there should be more to the confection, and more fun associated with the confection.

Wooden ice cream pop sticks have to be cut and milled from trees. Then only after a very brief usage, and for such a small benefit, and possibly a dangerous one, they are immediately thrown away, only to be thrown into landfills. If the ice cream pop sticks do escape the landfills, they are incinerated, which contributes to air pollution. Even if this is a small amount (but possibly in large quantities), if it can be avoided and done so with an even more positive and enjoyable affect, it will be a smart addition to the natural resource conservation programs we already have, to help save resources and minimize waste for current and future generations.

As a frozen confection lover approaches the end of the ice cream pop, he or she has to actually lick the wooden stick to obtain the last bit of the confection. The taste and texture of the wood is a negative one for most people, putting a damper and an unhappy ending to an experience that should be nothing but a pleasure.

Plastic sticks depending upon how they are constructed may also cause injury to a small child. Plastic sticks add to the cost of the confection and do not add to the taste of the confection. Plastic sticks have to be manufactured, which uses fuel, and generally non-biodegradable materials that are only used for a very short time and discarded. These too end up in landfills, add to air pollution, or need extra fuel to decompose or recycle them.

U.S. Pat. No. 4,399,153 (1983) to Tezuka et al. discloses an ice cream pop stick made of chewing gum, but chewing gum is not edible and chewing gum is a bad habit to promote in children.

Design U.S. Pat. No. 339,218 (1993) to Welsh et al. shows the design of an edible spoon. A second design patent, D338,993 (1993) to Lilly, also shows the design of an edible spoon. However these spoons do not solve the above problems with ice pops.

U.S. Pat. No. 5,980,456 (1999) to Falcone discloses an edible tongue depressor and method of use. Falcone states that he contemplates an edible support stick for frozen desserts.

Falcone's support stick does not bend and is not malleable. His support stick does not contain layers of different ingredients or composite ingredients, to provide a durable support with maximum flavor and taste, or provide a long lasting second dessert with an already familiar taste for the consumer. His stick does not provide for a moisture-proof barrier to allow healthy cookie, granola, pretzel sticks or other porous ingredients to be used as supports. Falcone's stick is thin and prone to breakage. The stick has flat ends and does not adapt to different configurations or orientations. Falcone's support stick is not freestanding and cannot stand alone on a flat surface or provide working confections that rock, roll, hang, spin, twist, whistle, is invertible or wearable for a child. His edible support does not support non-frozen confections or provide an edible confection kit or soft edible supports for very young children. Falcone does not have disposable manufacturing molds for efficient and cost effective manufacture of edible supports.

### OBJECTS AND ADVANTAGES

Accordingly, several objects and advantages of the present invention are:

(a) to provide an improved ice cream pop stick;

(b) to provide an ice cream pop stick that will not cause wooden splinters in the mouth or on the tongue of any person who's intent is to eat and enjoy a frozen hand-held or supported confection;

(c) to provide a safer ice cream pop support that will greatly minimize or eliminate injury to a child or person if they accidently fall with an ice cream pop stick in their hand or mouth, who may otherwise have sustained an injury;

(d) to provide an ice cream pop support that adds to the taste of the frozen confection, is totally edible and is not a needless waste of money;

(e) to provide an ice cream pop support that may be eaten without losing a portion of the ice cream pop due to the fact that ordinarily one has to eat around an inedible stick;

(f) to provide a new supported frozen confection that is a double confection that will provide the answer to the feeling that there should be more to the confection;

(g) to provide an ice cream pop stick which does less damage to the environment by not requiring wood from trees, less waste in the landfills and less pollution in the air; and

(h) to provide a hand-held frozen confection that is as delicious at the end of the confection as it is in the beginning.

Other objects are:

(i) to provide new, edible supports, where non-edible supports are replaced by edible supports, which can be totally eaten and doubly enjoyed;

(j) to provide an ice cream pop stick that does not melt within the frozen confection;

(k) to provide a better tasting comestible by adding numerous flavor combinations of the edible support to the flavors in the comestible;

(l) to provide a frozen confection where the frozen stick holds the cold more efficiently, keeping the ice cream colder, resulting in less dripping, while it is being eaten;

(m) to provide a way to keep fingers and clothing from getting messy or cold and still have a totally edible frozen confection;

(n) to design for easier consumption of the confection, since the user can eat the stick right along with the confection and not have to worry about “eating around the stick,” where the confection may fall off;

(o) to provide for those who may be allergic to chocolate and other ingredients or would like a reduced fat confection but still would like a totally edible supported confection;

(p) to delight children with whimsical confections and complimentary, efficient, edible sticks or supports in any design, shape, or orientation, which adds to their enjoyment of an edible confection;

(q) to provide safe, soft, edible supports that can be different shapes and sizes to accommodate the smallness of children's fingers and their unconventional methods of eating hand-held frozen confections;

(r) to provide edible supports to non-frozen comestibles;

(s) to make inexpensive supported comestibles using cookies, candies, pretzels, bread sticks and the like; and

(t) to provide an edible supported confection in small servings for those that want a little something sweet but not a lot of calories.

(u) to support comestibles with candy bars, cookie bars and the like, so people can purchase a confection with a familiar, consistent taste.

Still further objects are:

(v) to provide a kit for children to create a nutritious and fun snack, or festive party favor;

(w) to provide new supported comestibles such as edible supported cupcakes, brownies, marshmallow treats, cookies, lollipops and the like;

(x) to design totally edible functional confections that stand, hang, rock, roll, whistle, that are invertible, malleable, or that are wearable; and

(y) to provide a new edible skewer for appetizers and the like.

Reference Numerals in Drawings

60 edible homogenous support

62 edible rectangular composite support

62A edible cylindrical composite support

64 edible free form support

66 void

68 gripping edible support

70 edible malleable support (licorice, etc.)

72 edible tapered support

74 edible operational support

76 edible wafer mess guard

78 edible crumb mess guard

80 edible drip guard

82 sandwich cookies

82A chocolate-chip sandwich cookies

84 frozen confection

84A multi-flavored frozen confection

84B frozen ice confection

86 edible moisture-proof barrier/sealant/coating

88 caramel

90 nougat

92 marshmallow

94 nuts, rice, etc.

96 dense cookie support

97 dense pretzel, bread stick, support

98 edible freestanding support

100 additional fun ingredient ( thick chocolate, fudge, chocolate or rainbow chips, candy, toy shaped candy, gum, etc.)

102 non-frozen confection

104 push pop casing

106 finger

108 lollipop

110 inedible mess guard

112 packaging

112A tab on packaging

113 sandwich filling

114 stop guide

116 pretzel

118 stick aligning device

120 disposable mold

122 hors d'oeuvres

### DESCRIPTION OF THE DRAWING FIGURES

FIG. 1 is a perspective view of a frozen confection with a angular edible composite support with an edible mess guard, according to my invention.

FIG. 2 is a perspective view of a frozen confection with a cylindrical edible support with an edible mess guard, and an additional fun ingredient, according to my invention.

FIG. 3 is a perspective view of a tri-flavored, frozen confection with a homogenous edible support, according to my invention.

FIG. 4 is a perspective view of a twin frozen confection with twin homogenous edible supports, according to my invention.

FIG. 5 is a perspective view of a frozen confection with a free form edible support having a void and an edible mess guard, according to my invention.

FIG. 6 is a perspective view of a frozen confection with an edible support having an easy grip shape for the hands, according to my invention.

FIG. 7 is a plan view of a balloon-shaped, frozen confection with a malleable edible support, with a moisture-proof coating on its upper end, according to my invention.

FIG. 8 is a perspective view of a frozen confection with a malleable edible support with a moisture-proof barrier coating or sealant on its upper end, according to my invention.

FIG. 9 is a perspective view of a frozen confection with a malleable edible support that has a void and a moisture-proof barrier coating on its upper end, according to my invention.

FIG. 10 is a plan view of a frozen confection with a horizontally oriented, malleable, edible support, that has two voids and a moisture-proof barrier coating, according to my invention.

FIG. 11 is a perspective view of a frozen confection with a horizontally oriented, cylindrical edible support, and mess guards, according to my invention.

FIG. 12 is a plan view of a barbell-shaped, frozen confection with a horizontally oriented edible support, having a moisture-proof barrier/coating, and a mess guard, according to my invention.

FIG. 13A is a side view of a frozen confection with a tapered edible support that has two added confections on the upper end of the edible support, according to my invention.

FIG. 13B is a side view of an inverted, free-standing, coated, frozen confection with a tapered edible support and a single added confection, according to my invention.

FIG. 13C is a side view of an inverted, free-standing, coated, frozen confection with a tapered edible support and a wider base, according to my invention.

FIG. 13D is a top view of a edible support aligning device to align the support until the confection is frozen, according to my invention.

FIG. 14 is a perspective view of a frozen confection with a cylindrical edible support, and a container that can be pushed to expose the confection, according to my invention.

FIG. 15A is a perspective view of a frozen confection with a edible support that is flattened and widened on it s upper end, according to my invention.

FIG. 15B is a perspective view of the edible support of 15A, that has twin voids and an edible crumb mess guard, according to my invention.

FIG. 15C is a perspective view of the edible support of 15B, that has an edible drip guard and an edible crumb mess guard, according to my invention.

FIG. 15D is a perspective view of the edible support of 15C, that is supporting a frozen confection, according to my invention.

FIG. 16A is a plan view of a tree-shaped, frozen confection with a cylindrical grip-shaped, edible support, according to my invention.

FIG. 16B is a plan view of a pony-shaped, frozen confection with a cylindrical, edible support, according to my invention.

FIG. 16C is a plan view of an umbrella-shaped, frozen confection with a cylindrical, hook shaped, edible support, according to my invention.

FIG. 16D is a plan view of a small frozen confection supported by a marshmallow bunny candy support, according to my invention.

FIG. 17 is a plan view of a frozen confection with a cylindrical, Y-shaped, edible support, having twin frozen confections, each with an added confection, according to my invention.

FIG. 18 is a plan view of a person-shaped frozen confection with a moisture-proof coated cookie, having a void, mess guard and added confections, according to my invention.

FIG. 19 is a plan view of a dinosaur-shaped frozen confection with an “edible spine” support passing through the frozen confection, according to my invention.

FIG. 20 is a perspective view of a rectangular edible support with a mess guard, supporting a frozen sandwiched confection, according to my invention.

FIG. 21 is a perspective view of a cylindrical edible support, with a mess guard, supporting a frozen confection sandwiched with chocolate-chip cookies, according to my invention.

FIG. 22 is a perspective view of an edible spoon support, with a mess guard, supporting a frozen confection, according to my invention.

FIG. 23 is a perspective view of a frozen confection with a rectangular edible support, an added confection, and a non-edible mess guard in protective packaging, according to my invention.

FIG. 24 is a perspective view of a combination protective packaging and disposable mold apparatus, according to my invention.

FIG. 25A is a perspective view of a pony-shaped, freestanding frozen confection with a cylindrical, edible support with a circular base and mess guard, according to my invention.

FIG. 25B is a perspective view of a freestanding frozen confection with a cylindrical edible support with a circular base, and a mess guard, according to my invention.

FIG. 25C is a perspective view of a freestanding frozen confection with a rectangular edible support with a square base, and a mess guard, according to my invention.

FIG. 26A is a plan view of a mini-size frozen confection supported by a cookie with a chocolate moisture-proof barrier, according to my invention.

FIG. 26B is a plan view of a mini-size frozen confection supported by cookie with a moisture-proof barrier that can be placed on a finger, according to my invention.

FIG. 26C is a perspective view of a spoon-shaped, mini-size, frozen confection, according to my invention.

FIG. 26D is a plan view of a mini-size frozen confection supported by a cookie with a moisture-proof barrier and a mess guard, according to my invention.

FIG. 26E is a plan view of a mini-size frozen confection supported by a free-form cookie with a moisture-proof barrier/sealant/coating and a mess guard, according to my invention.

FIG. 27A is a cross-section of an edible support made with a pretzel dipped in yogurt, according to my invention.

FIG. 27B is a cross-section of an edible, composite, rectangular support having caramel and cookie center and a chocolate moisture-proof barrier, according to my invention.

FIG. 27C is a cross-section of an edible, composite, rectangular support having rice, nuts, etc. in caramel and a chocolate moisture-proof barrier, according to my invention.

FIG. 27D is a cross-section of an edible, composite, rectangular support having a layer of caramel and a layer of whipped nougat, covered with a chocolate moisture-proof barrier, according to my invention.

FIG. 27E is a cross-section of an edible, composite, rectangular support, having a dense marshmallow center, covered with a chocolate moisture-proof barrier, according to my invention.

FIG. 28 is a perspective view of a homogenous edible support, according to my invention.

FIG. 29 is a perspective view of a sandwich cookie, edible support with filling, covered with a chocolate moisture-proof barrier, according to my invention.

FIG. 30 is a plan view of a cookie edible support, with an additional fun ingredient, such as peanut butter, covered with a chocolate moisture-proof barrier, according to my invention.

FIG. 31 is a cross-section of a cylindrical edible support, with an elongated cylindrical cookie, encased in caramel and covered with a chocolate moisture-proof barrier, according to my invention.

FIG. 32 is a perspective view of a fort-shaped, non-frozen confection, having a free-standing edible base, according to my invention.

FIG. 32A is a perspective view of the free-standing edible support of FIG. 32, according to my invention.

FIG. 32B is a perspective view of an alternative free-standing edible support, to that seen in FIGS. 32, 32A and 33, according to my invention.

FIG. 33 is a perspective view of an alien-shaped, non-frozen confection, on a free-standing support, according to my invention.

FIG. 34 is a perspective view of a fort-shaped, non-frozen confection with rectangular cookie supports and a cookie chimney, according to my invention.

FIG. 34A is a perspective view of a cookie support used in the confection of FIG. 34, according to my invention.

FIG. 35 is a perspective view of a fort-shaped, non-frozen confection with peg-like candy supports and a cookie chimney, according to my invention.

FIG. 35A is a perspective view of the candy support used in the confection of FIG. 35, according to my invention.

FIG. 36 is a perspective view of a pony-shaped, non-frozen confection with peg-like candy supports, according to my invention.

FIG. 37 is a perspective view of a dinosaur-shaped, non-frozen confection with cookie leg supports, and a cookie head and tail, according to my invention.

FIG. 38 is a perspective view of a rolling, car-shaped, non-frozen confection with edible wheels and axil supports, according to my invention.

FIG. 39 is a perspective view of a operative, rocking horse-shaped, non-frozen confection with edible cookie rocking supports, according to my invention.

FIG. 39A is a perspective view of a rocking cookie support of FIG. 39, according to my invention.

FIG. 39B is a perspective view of an edible stick used to skewer cheese, meat slices and an olive, according to my invention.

FIG. 40A is a plan view of a golf ball-shaped, non-frozen confection with a tee-shaped edible support, according to my invention.

FIG. 40B is a plan view of the tee-shaped edible support of FIGS. 40A and 40D, according to my invention.

FIG. 40C is a plan view of the tee-shaped edible support with a stop guide, according to my invention.

FIG. 40D is a plan view of a tree-shaped, non-frozen confection with a tee-shaped edible support, according to my invention.

FIG. 41A is a plan view of a lollipop confection with an edible tee-shaped, free-standing edible support, according to my invention.

FIG. 41B is a plan view of a lollipop confection with a homogenous edible support and an added confection, according to my invention.

FIG. 41C is a plan view of a ginger bread man-shaped lollipop confection with a homogenous edible support, according to my invention.

FIG. 41D is a plan view of a pony-shaped lollipop with a free-standing edible support, according to my invention.

FIG. 42 is a plan view of a lollipop with a malleable support and an added fun confection, according to my invention.

FIG. 43 is a plan view of a malleable, edible confection and edible, candy beads used as a bracelet or necklace, according to my invention.

### SUMMARY

In accordance with the present invention, I provide a totally edible, utilitarian, support for a comestible or food item, to replace, the present day, non-edible supports. It is a totally new and superior change to provide confections on edible sticks and supports, rather than on non-edible wooden or plastic sticks. A frozen ice cream pop may now be eaten, stick and all. Edible supports are used to support non-frozen comestibles as well as frozen ones. As a result, new confections have been created, such as cupcakes on supports and edible skewers made of dense pretzels, bread sticks, homogenous comestibles, (or other ingredients) for hors d'oeuvres.

An innumerable amount of flavor choices may be combined, now that the support may have flavors of its own and be eaten as well. Edible supports are extremely versatile and may be made of a great many inexpensive ingredients. Kits containing all the ingredients and molds needed, provide fun for parties or after school treats. According to my invention, edible supports may be made of almost any comestible, in any flavor, shape, size or dimension.

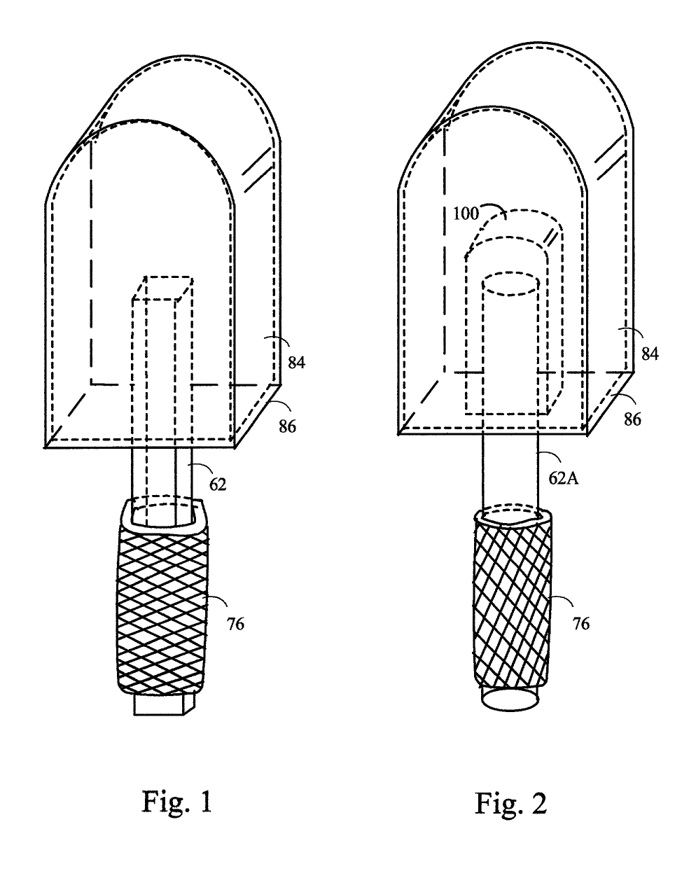

FIG. 1—Edible Rectangular Supports for Frozen Comestibles with Protective, Edible Mess Guards and Moisture-Proof Barriers/Coatings

The following illustrations are not to scale and are provided for the fundamental understanding of the disclosed invention along with its description. The features illustrated in the drawings may be combined for different applications, or other methods may be used. Moisture-proof barriers/coatings/sealants 86, mess guards 76, 78 and drip guards 80, may be used anywhere when needed.

FIGS. 1 through 33 will be described as frozen comestibles for the purpose of a clear illustration and description; however the edible supports illustrated in these figures are also used for non-frozen comestibles as well, such as cake, cookies, etc. The words, “ice cream” will be used for the most part in the ensuing description, but any other suitable confection, such as ices, ice milk, frozen juices, sorbet, frozen yogurt, frozen pudding, pureed fruit, etc., are also used. Barrier/coating 86 is used for multi-purposes, such as a moisture barrier on an edible support and a tasty coating on a frozen comestible. Barrier 86 is used to partially coat or totally coat a comestible as needed.

FIG. 1 shows a frozen ice cream pop having a frozen confection 84 on the top, such as ice cream, frozen pudding, etc. Confection 84 is supported by an edible rectangular composite support 62, which has been inserted into confection 84. Stick 62 serves as a handle for the user. Support 62 is made of a candy bar-like combination that has different ingredients.

The chocolate coating (or other moisture-proof ingredient) of support 62 serves as a moisture-proof barrier/coating/sealant 86 between confection 84 and the other ingredients inside of support 62. If support 62 has a cookie, granola, or pretzel (or other absorbing or porous ingredient) in it, barrier 86 insulates the cookie, etc., from the moisture found in confection 84 and keeps the cookie crisp and strong so it may be used as a strong and nutritious support. Barrier or coating 86 is made of milk chocolate, semisweet chocolate, white chocolate, flavored chocolate, a dried yogurt coating, suitable shortening or oils, a fudge in any flavor, such as white fudge, chocolate fudge, peanut butter fudge or maple fudge or any other moisture sealing ingredient.

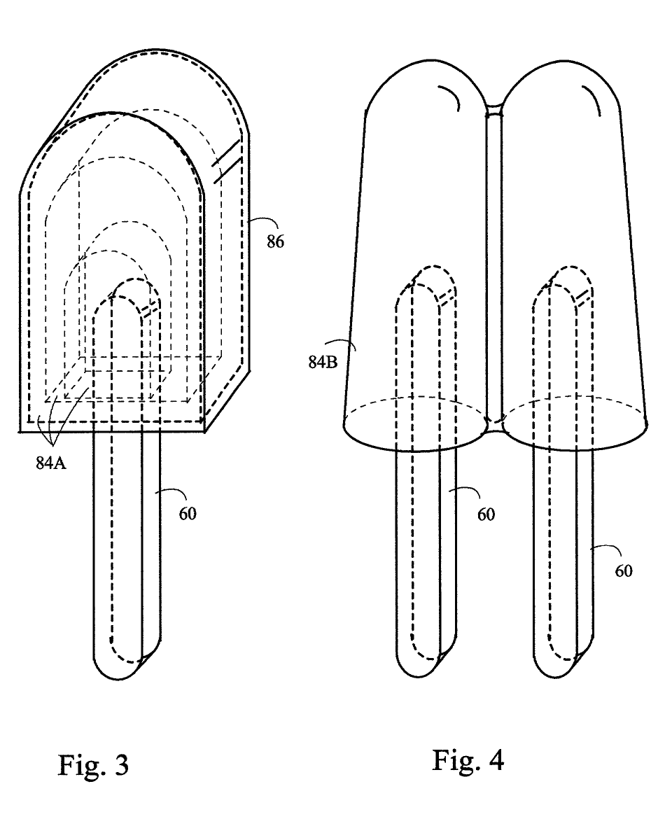

Some confections, such as a candy canes or swizzle sticks, when inserted in a liquid-type confection,(such as ice cream) melt and will not adhere to frozen confection 84 because the moisture in the ice cream melts the outer layer of the candy cane or swizzle stick. Ice cream or other liquid-type frozen confections adhere nicely to chocolate (or other) barrier 86. Barrier 86 adheres to candy canes and swizzle sticks. Providing barrier 86 to these kinds of confections keeps the support from melting when that portion of it is inserted into confection 84 and provides adherence of frozen confection 84 to melting-type supports. Barrier 86, on the inserted portion of support 62, (or any edible support) provides a very secure, long lasting hold on confection 84, so that support 62 does not slip or slide within confection 84. Barrier 86 often makes the successful combination of support 62 (or other supports) and confection 84 possible. Barrier 86 is also used as a coating or dip for the outside of confection 84, (FIG. 1 and 2) or between multiple layers of confection 84 (FIG.3).

Support 62 has a protective edible mess guard 76 on its lower portion. Protective mess guard 76 is pictured as a thin sheet of cookie wafer that is wrapped around a predetermined portion of support 62 but is adaptable for any thickness, ingredient or place. Mess guard 76 are placed as strips, geometric segments, or other shapes or methods. They cover all of the exposed portion of support 62 or just a portion of it, as needed. Mess guard 76 provides a physical barrier and effectively keeps the fingers from melting the ingredients when the user's warm fingers come in contact with the chocolate or other coating, during consumption of the confection. Mess guard 76 is especially beneficial if support 62 is held tightly, as by a child, or for a long period of time.

Preferably, support 62 is an elongated and slenderized, multi-ingredient, candy bar (made to a suitable size and shape to support the confection) such as those found at the check-out counter of a grocery store.

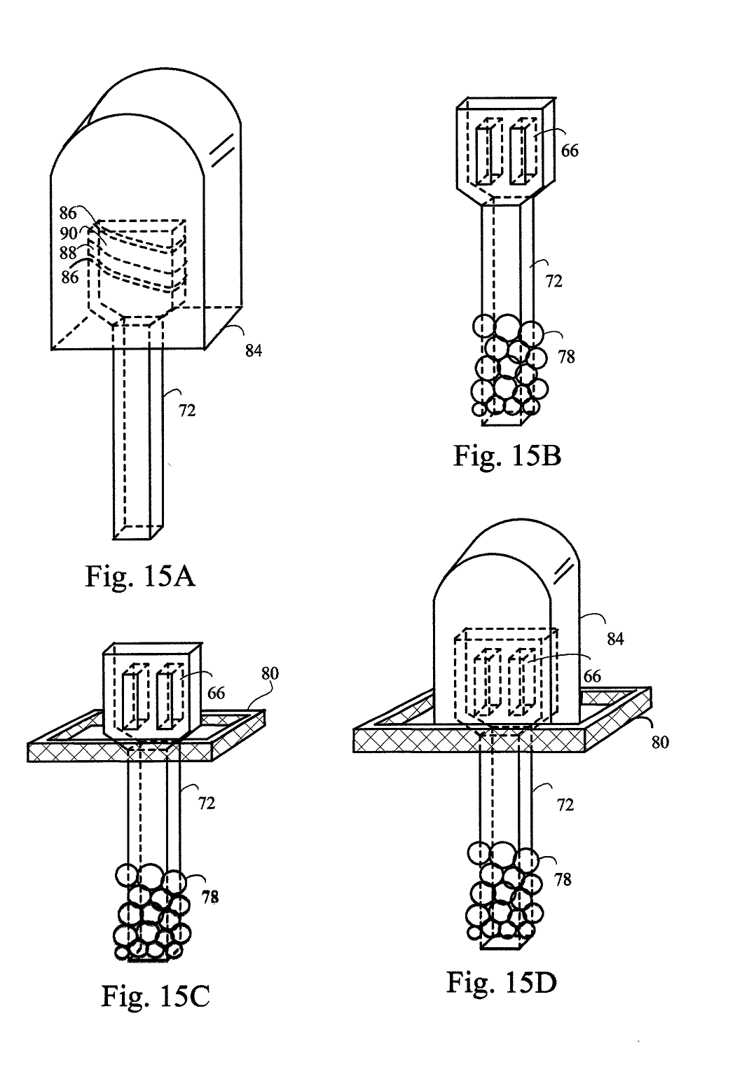

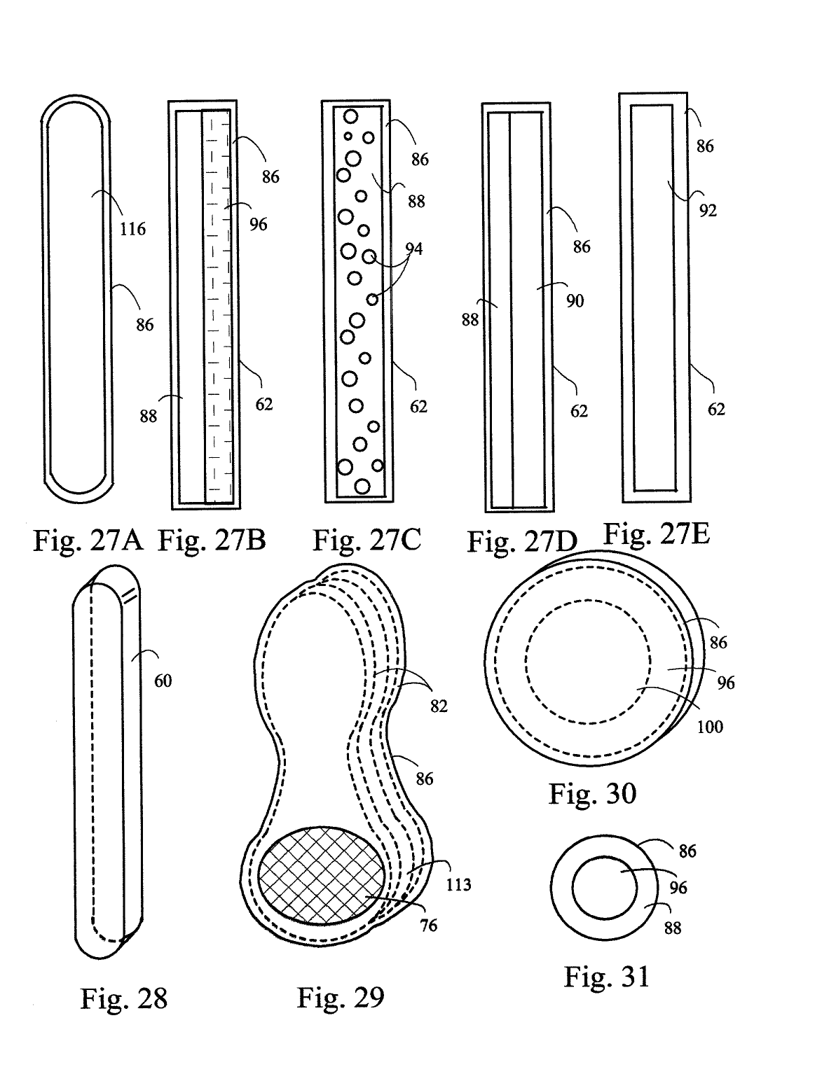

One such candy bar has the ingredients of a whipped chocolate nougat center that is then coated with a thick chocolate coating (barrier 86), sold under the trademark Three Musketeers by Mars, Incorporated of Hackettstown, N.J. Another suitable candy bar that contains the ingredients of a whipped chocolate nougat center 90, topped with a thick layer of caramel 88, which is then totally dipped in a thick chocolate coating 86 (FIG. 27D), is one sold under the trademark Milky Way, also by Mars, Incorporated. (The ingredients and barrier or chocolate coating 86 are not specifically shown in support 62 in FIGS. 1 and 2, for clarity, but are shown in FIGS. 15A, 27A-E). Another suitable candy bar for an edible support is made with the ingredients of an elongated dense cookie, coated on top with a thick layer of caramel, which is then dipped in a chocolate coating,(FIG. 27B) such as the one sold under the trademark Twix, also by Mars, Incorporated. A frozen Twix candy bar efficiently supports confection 84.

Other candy bars that are also suitable as edible supports for confection 84, such as the one sold under the trademark, Butterfinger, by Nestle Incorporated, of Glendale, Calif., has the ingredients of ground roasted peanuts, dipped in a thick chocolate coating (and other ingredients) and one sold under the trademark Snickers, also by Nestle, has peanuts, caramel and a chocolate coating. Another candy bar sold under the trademark 100 Grand, also by Nestle, has the ingredients of chewy caramel, milk chocolate and crispy crunchies (FIG. 27C). 100 Grand candy bar, if slenderized, elongated and frozen is an efficient support 62 for confection 84. A candy bar sold under the trademark Baby Ruth, also by Nestle, with the ingredients, peanuts, caramel and nougat, also if slenderized is a rich, edible support for confection 84. Other suitable candy bars are the candy bars sold under the trademarks Mounds and Almond Joy, both by Hershey Foods Corporation, of Hershey, Pennsylvania. These supports may be any size, length, width, shape or thickness. A bite size additional fun ingredient 100, sold under the trademark Nestle Bites also of Nestle Incorporated, which has several flavors, may be added to confection 84 or an edible support for additional enjoyment. These candy bars offer a familiar and desired taste to many people in the United States and to many people of other countries throughout the world.

A chocolate covered and slenderized granola bar or cereal bar also is an efficient support 62. One such granola bar is sold under the trademark Kudos by Mars, Incorporated, of Hacketstown, N.J. This granola bar when shaped, frozen and inserted into softened ice cream or frozen yogurt and placed in the freezer provides a totally edible, supported, and nutritious frozen confection.

Popular fudge cookies sold under the trademark Fudge Shoppe Fudge Sticks and Fudge Shoppe Peanut Butter Fudge Sticks, by The Keebler Corporation of Elmhurst, Ill., have multi-layered wafered cookie ingredients, may be dipped in a thick fudge coating, and easily used to support a small confection 84 or confection 102 for a child or small portion.

A chocolate covered fudge candy, sold under the trademark Riesen Candies and made in Germany, by Storck USA of Chicago, Ill. is adaptable to support confection 84 if elongated and frozen. A candy bar sold under the trademark Cadbury Caramello of Hershey Foods Corporation, of Hershey Pennsylvania, if unsegmented, supports confection 84. Another candy bar sold under the trademark Heath Bar also by Hershey Foods, serves well as support 62.

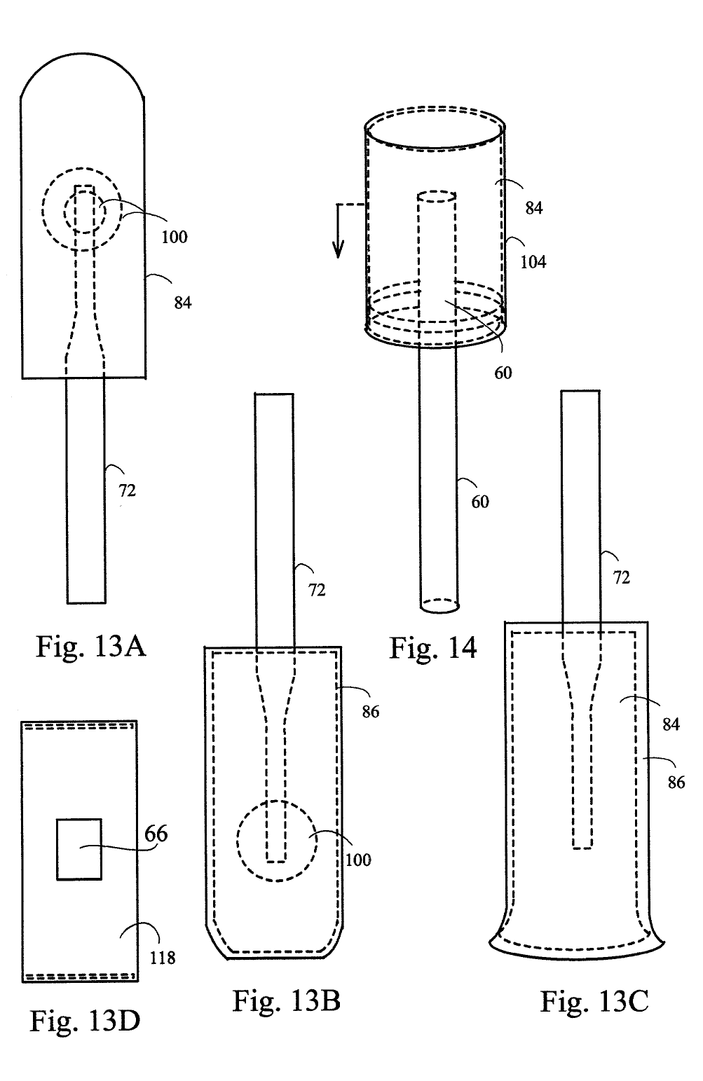

Additional fun ingredients 100 (FIGS. 13A, 13B) may also be added as a separate piece of candy (gum, gelatin figure, etc.) that is shaped like a toy, such as an animated cartoon, a figure, or animal, etc. Additional fun ingredient 100 may be placed inside or outside confection 84 or inside or outside an edible support to be a “treasure find” (not shown) for a child. A treasure or prize may be placed in each pop or one may be placed in a single pop or in a box of a number of pops, for a “lucky winner.”

Support 62 (and the other supports) retain the cold much longer than a regular wooden or plastic stick. Since support 62 is deeply frozen and is partially situated inside confection 84, it acts to keep confection 84 colder from the inside for a longer period of time. This prevents confection 84 from melting and dripping as quickly as with a prior-art stick. Because support 84 is frozen, confection 84 does not have to be eaten in such a rush and the confection may be enjoyed for a longer period of time. This is most advantageous for small children.

When eating the ice cream pop, the user may prefer to eat frozen confection 84 first and save stick 62 for a second dessert. As an alternative method, the user has the option to eat confection 84 until the user reaches the inserted portion of support 62. The user may then eat support 62 simultaneously with confection 84 until confection 84 is finished. The user then still has a second dessert to eat, which is the remainder of support 62. The user may try eating the edible support ice pop different ways on different occasions.

FIG. 2—Edible Cylindrical Support for Frozen Comestibles with Protective, Edible Mess Guards and Moisture-Proof Barrier/Sealants/Coatings

FIG. 2 shows a frozen ice cream pop having frozen confection 84 on the top, similar to the pop of FIG. 1. Frozen confection 84 is supported by a similar edible, cylindrical-shaped stick 62A, which has been inserted into confection 84. The inserted portion of stick 62A has been topped with or dipped into an additional fun ingredient 100, 108, such as fudge, chocolate, or toffee, (gum or any confection). This provides a lollipop within a frozen confection for a child. In FIG. 2, stick 62A also serves as a handle.

The different ingredients within stick 62A may be arranged concentrically as in FIG. 31, with a cylindrical cookie on the inside covered by caramel (or other method), which is then dipped in a chocolate, yogurt, etc., moisture-proof barrier 86. More than one kind of barrier 86 may be layered to add more flavor. The ingredients within support 62A may also be reversed, layered, horizontally or vertically, swirled or twisted together and covered with barrier 86 and mess guard 76. This embodiment also has mess guard 76 for the fingers.

FIG. 3—Edible Homogenous Support for Frozen Comestibles

FIG. 3 shows a frozen ice cream pop having an upper frozen confection with a multi-flavored confection 84A. Three different flavors or colors of a confection or three different confections are shown, such as a combination of confections containing ice cream, sorbet and yogurt. More or fewer may be used. If desired, each flavor may be dipped into barrier 86, such as a thin layer of chocolate before being put in a larger mold, or dipped and coated with the next and larger flavor. This gives confection 84A a light crunch texture as well as a light chocolate flavor. A non-moisture-proof barrier may also be used between the layers of confection 84A, such as a thin layer of sherbert, cookie or candy crumbs, a thin layer of peanut butter, nuts, cereal, caramel, etc.

Confection 84A is supported by a homogenous edible support 60. Support 60 has a homogeneous composition. It may have several ingredients but the ingredients are homogenized rather than layered (or slightly mixed—i.e. a granola bar), as seen in support 62 in FIG. 1 above, that has discernable individual ingredients. Support 60 may also be just one ingredient, (other than water) such as sugar (rock candy stick), and is used as a handle in this figure.

One suitable stick-like homogenous support 60 is sold under the trademark Lik-m-aid manufactured by Sunmark, Inc. of St. Louis, Mo. Such a stick has been used to gather flavored sugar from an adjacent pouch when the stick is moistened. Edible support sticks containing the ingredients of Dextrose, Maltodextrin, Citric Acid, and Magnesium Stearate, and flavoring, may be directly used to support comestible 84, 84A, 84B (and others). Elongating this support is preferable. These sticks work extremely well as support sticks and do not need mess guards 76, 78. Different colors, flavors, textures and shapes of support 60 can be used, such as layers of rainbow colors from front to back or up and down. This kind of support can also be constructed in a speciality mold to depict an animated character or item which is viewable in either in the surface area that is inside confection 84, in the outside area of support 60, or both if desired, so that the figure's identity is totally disclosed only after confection 84 is consumed. Support 60 can be made in the shape of a whistle capable of making a whistle sound, and thus can be used both as support 60 and as a toy. Other shapes that naturally supply more fortification or support to confection 84A, etc. are also used.

Other supports include other candies which have mixed ingredients and can be moisture sealed, like swizzle sticks, candy canes, thick chunks of chocolate and marshmallow. Sealing marshmallow is optional. The upper part of support 60 may be dipped in barrier 86 where it comes in contact with confection 84A if desired, which provides an even longer shelf (freezer) life in the stores. Barrier 86, including a dried yogurt coating, peanut butter fudge, chocolate, semi-sweet, and white chocolate, etc., provide solid, moisture-proof support, for a very long shelf life. A thick block of chocolate, such as the one sold under the trademark Chunky by Nestle Incorporated, when reshaped, is adaptable to support another comestible. A thick mess guard 76 is easily embedded in or placed on (around, etc) its lower portion, front and back, to prevent melting by warm fingers.

FIG. 4—Edible Twin Homogenous Supports for Frozen Comestibles

FIG. 4 shows a frozen confection that has twin frozen confections 84B and twin homogenous edible supports 60. This confection can usually be separated into two confections and shared. This type of confection is traditionally made of an iced confection, but is not limited to ice. Barrier 86 may be used to coat the inserted portion of support 60 for a longer shelf life (not shown). Supports 60 are used as twin handles.

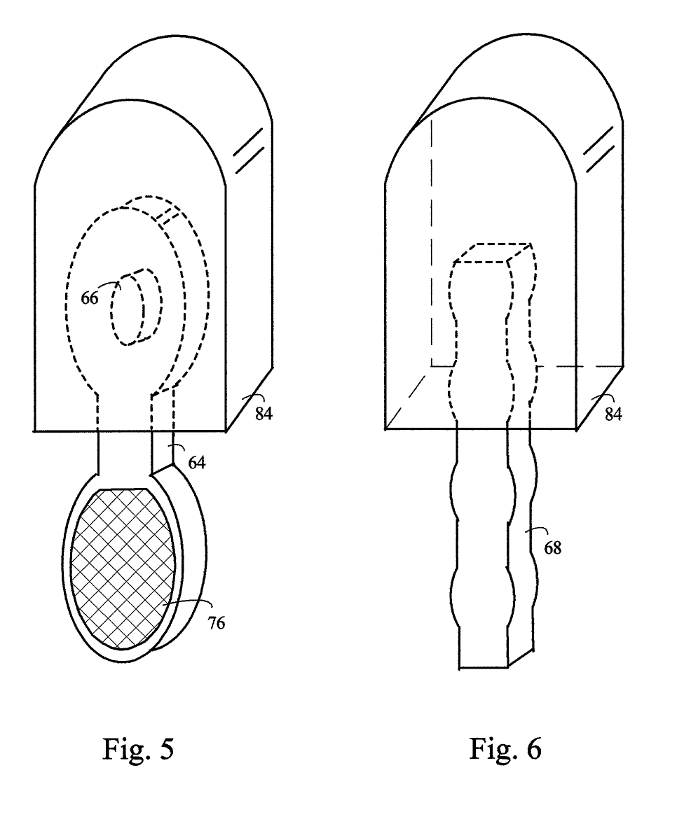

FIG. 5—Free Form Edible Support for Frozen Comestibles

FIG. 5 is a frozen confection supported by an edible free form support 64, with a void 66 within frozen confection 84. Free form support 64 can be constructed in any shape, size, or dimension that is desired, such as an animated figure or structure. Support 64 is shown with composite ingredients as in support 62, but it can also be made as support 60, 70. Void 66 provides a better gripping surface for adherence of confection 84. The front of confection 84 flows through void 66, and attaches to the back of confection 84, unifying confection 84. This gives additional adherence, so that confection 84 does not prematurely fall off support 64 during consumption. Support 64 also has a large handle to hold. Mess guard 76 keeps the fingers clean. Providing a textured surface to barrier 86, or the surface of support 64 (or any other edible support) also lends extra adherence of confection 84 to support 64. A textured barrier 86 also is easier to grip with the fingers.

FIG. 6—Gripping Handle Edible Support for Comestibles

FIG. 6 shows an easy to grip, edible composite support 68. Support 68 has indentations for the fingers. Support 68 is used here as a handle. Edible mess guards 76 (FIG. 1) can be used here as well.

FIGS. 1-6—Manufacture and Use of Edible Composite Supports for Frozen Comestibles

In FIGS. 1-2, elongated and slenderized supports 62 can be specifically arranged to be manufactured by candy companies who have the corresponding ingredients in their candy bars.

Frozen confection 84 can be poured or pressed into a mold, designed for a particular frozen confection. Support 62, support 60, or any edible stick, with or without mess guards, are inserted into confection 84 or into the mold before confection 84 is poured.

Support 62 (or any edible stick) can be pre-frozen and then inserted into frozen confection 84 or it can be at room temperature and inserted into slightly softened confection 84, for freezing along with confection 84, during manufacture. After confection 84 is frozen, the ice cream pop is removed from the mold and dipped in coating 86, or nuts, chopped candy, crisped rice, cookie crumbs 94, or any coating if desired, and packaged.

Composite supports 62 can be manufactured with ingredients that sustain more stress against breakage, such as caramel. Ingredients can run in any direction (or a combination of directions), such as diagonally within composite stick 62 to inhibit the horizontal breaking of composite support 62. Specific combinations and multi-layers of ingredients can also make the supports stronger. Different ingredients running concentrically, parallel or maneuvered within the stick, such as twisted within support 62 (or other supports) make the stick stronger and less prone to breakage. The monitoring of the amounts of moisture, shortening, sugar, air and air bubbles, etc. can create stronger supports.

Protective packaging, shipping and handling can also ensure intact products. Edible mess guards can be added in ways to strengthen and prevent damage to the edible supports, such as wrapping edible mess guards 76 around the edible supports or placing them on all sides of the edible supports.

Almost any ingredients or comestibles can be used as edible supports for other comestibles, if they are prepared in a manner to do so, such as providing density, a proper shape and thickness relative to the ingredients strength, and barriers 76, where needed. Edible supported confections can be made in extra large sizes for extra enjoyment.

A list of some suitable supports, are as follows:

composite candy bar with caramel, whipped chocolate nougat which is dipped in chocolate

composite candy bar with an elongated cookie stick, with caramel on top of the caramel, which is then dipped in chocolate

candy bar of chocolate nougat dipped in chocolate

composite candy bar with chocolate, nuts and nougat inside

chocolate covered dense marshmallow candy bar, plain, chocolate,

cherry or strawberry marshmallow (any flavors), twisted flavors or colors of marshmallow, marshmallow covered with sugar crystals,

chocolate covered coconut candy

chocolate covered fudge candy

chocolate covered mint candy or mint cookie

chocolate covered peanut butter candy bar

chocolate covered caramel stick

chocolate covered mint candy stick

chocolate or white fudge covered graham, ginger, mint, etc., cookies

yogurt, fudge, white chocolate, or chocolate covered cookies, pretzels, cheese (or other) crackers, bread sticks, and potato sticks, of any kind

yogurt, fudge, white chocolate, or chocolate covered granola bar

granola bars, whole grains, cereal bars, and other ingredients specially made for watching weight

licorice stick, (pliable, or non-pliable), for use as a stick or a necklace or bracelet, any flavor

Support 60 can be made in a clear or translucent color. White granulated sugar when dissolved turns from a white color to a clear color. Dissolved sugar may be poured into a mold in the shape of an edible ice pop stick. When it hardens, in a clear color, it may then be coated with a clear, vegetable oil based, (or other) barrier 86, and used to support confection 84. Support 60 also is also adaptable to be made in a edible stick of crystalized sugar, such as the confection sold under the trademark Rock Candy. Other colors can be added to give a beautiful, translucent or opaque, gem-like appearance to the edible support. The inserted end of this support may be coated with barrier 86.

Edible mess guards 76 are seen in FIGS. 1, 2, and 5 (and other figs). Mess guard 76 is a piece of wafer cookie, cone pastry, etc., that easily adheres to support 62 if it is placed on support 62 shortly after it has been dipped in chocolate (or other coating 86, during manufacture. Mess guard 76 can also easily be adhered at another time by slightly heating support 62 or by using melted chocolate as an “edible glue.” Confection 84 is dipped in chocolate coating 86 on the outside of FIGS. 1 and 2. FIG. 5 has mess guards 76 in an oval shape of wafer cookie that has been placed on the lower portion of support 64. The back of this ice pop is equipped with mess guard 76 as well. Other ingredients may also be used to make mess guards as well, such as, pita bread, cereal, or pretzel shapes or wraps, etc.

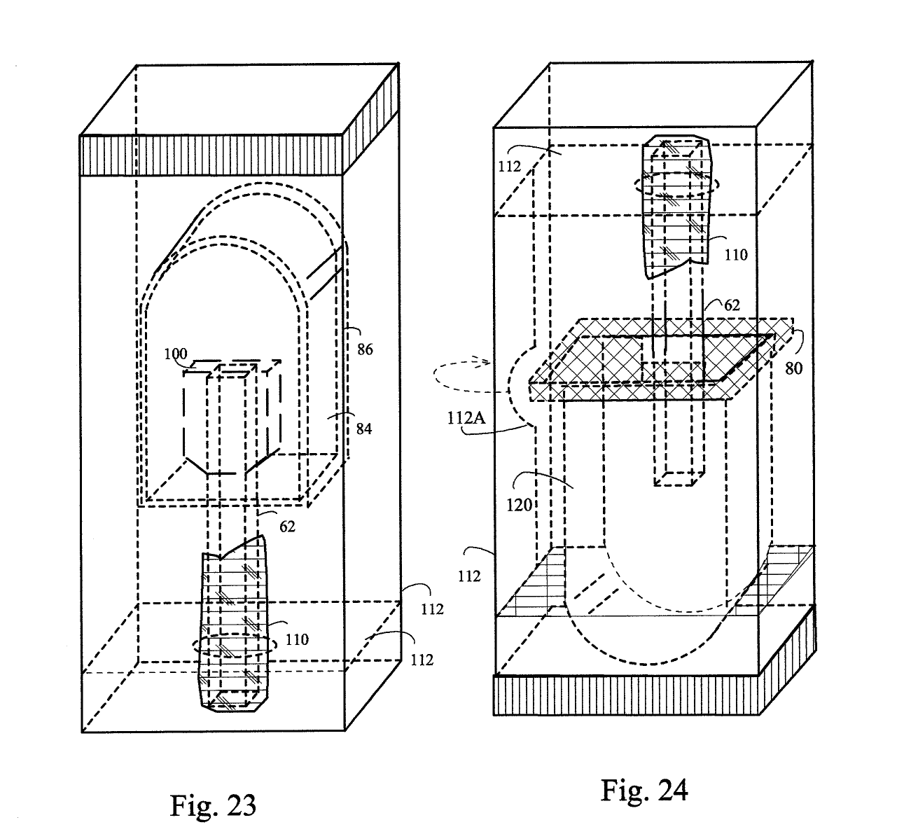

Sanitary packaging, such as boxes,(FIG. 23), cups, wrappers, or partial wrappers, are used to ensure the customer receives a clean and sanitary product.

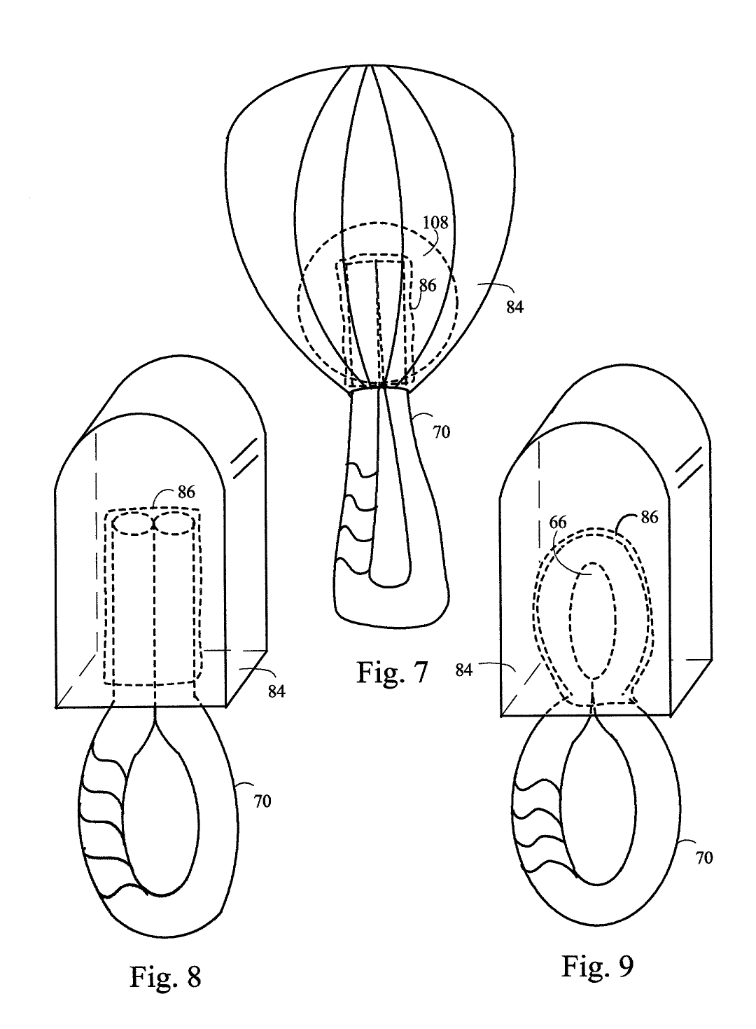

FIG. 7—Description of a Balloon Shaped Edible Confection with a Malleable Support

FIG. 7 shows confection 84 supported by a malleable, edible support 70, such as a substantial, length of thick licorice, (excluding shoestring) commonly found in most grocery stores in the United States. One such candy is sold under the trademark Twizzler by Hershey Foods Corporation of Hershey, Pennsylvania. Support 70 has been looped over and dipped in barrier 86, which secures the ends together when barrier 86 solidifies. An added confection 108 is shown on the inserted portion of support 70. This creates a lollipop within an ice pop that is totally edible. A barrier coated cookie 96 or sandwiched cookie 82 can also be placed on top of the inserted portion of support 70 to make a cookie and frozen ice pop confection. A length of licorice is often hollow. The hollow middle may be filled with a more fluid-type additional fun ingredient 100, or filled with another flavor of shoestring licorice, or other confection, such as little candy beads.

FIG. 8—Description of Traditional Ice Pop with U Shaped Malleable Support

FIG. 8 is traditional shaped confection 84 supported by a “u” shaped malleable support 70. The terminal ends of support 70 are secured by barrier 86. Support 70 can be looped or curved during manufacture while still in a warm, or semi-fluid state to prevent cracking. Support 70 is adapted to be any configuration as desired. Additional loops can be added to create an open spherical support (not shown).

FIG. 9—Description of Traditional Ice Pop with U Shaped Malleable Support

FIG. 9 illustrates support 70 as a “FIG. 8” and is covered with barrier 86 on its upper end, within confection 84. Barrier 86 fills in void 66 in its inserted end, adding strength to support 70. If barrier 86 is eliminated, (also works well without it) or allowed to thinly coat void 66 in its upper end, frozen confection 84 flows through void 66 of support 70 and provides an extra adherence of confection 84 to support 70.

FIGS. 7-9—Manufacture and Use of Edible, Malleable Supports

FIGS. 7-9 shows edible malleable support 70 as made of a flexible comestible, such as licorice. In FIGS. 7 and 8, a length of licorice is doubled over leaving a loop at one end. The free ends are temporarily tied together, and then dipped in barrier 86, such as melted chocolate (or other ingredient). When barrier 86 solidifies, barrier 86 holds the free ends together and the tie is taken off, since it is no longer needed. An edible tie may be used and left on (not shown). Support 70 can then be used to support confection 84.

In FIG. 9, edible support 70 is shown in the shape of a figure eight. The inserted end of edible support 70 is dipped in barrier 86. Void 66 can either be lightly dipped in barrier 86 and left open or filled in with barrier 86. Edible support 70 is frozen and more stiff when the ice cream pop is first taken out of the freezer. Edible support 70 softens a bit while confection 84 is being eaten. After confection 84 is consumed, support 70 is a bit warmer and softer to eat, but support 70 can be simultaneously eaten with confection 84, if desired. Support 70 serves as a handle in FIGS. 7-9. Support 70 is made in any shape to compliment the design of confection 84.

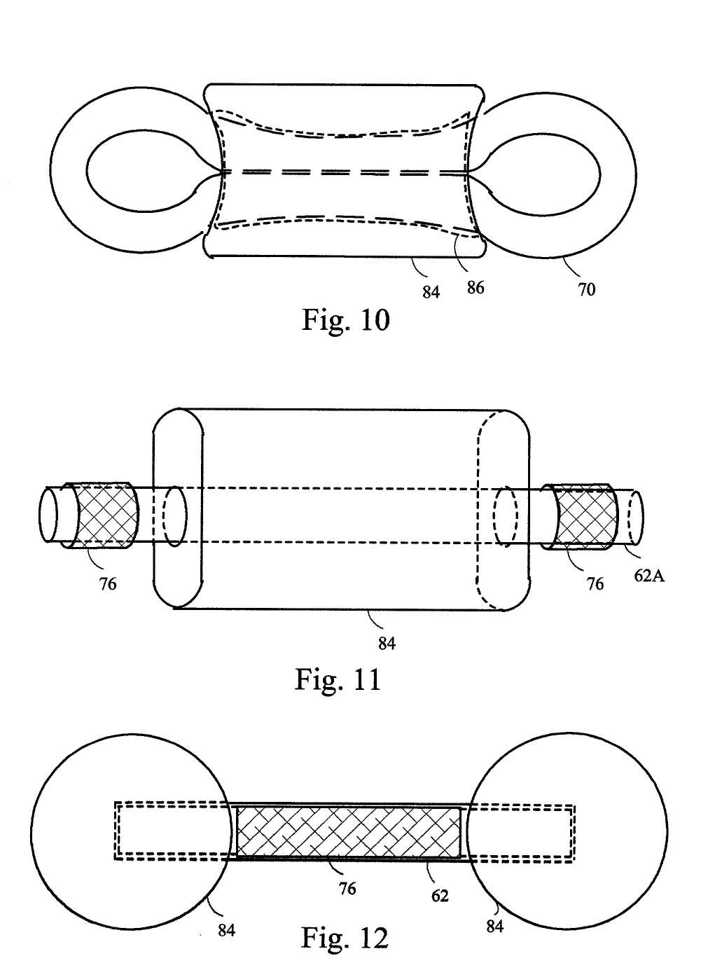

FIG. 10—Description of Malleable Horizontally Supported Comestibles

FIG. 10 shows confection 84 that is supported by malleable support 70 which has a horizontal orientation. Support 70 is situated horizontally within confection 84. Support 70 is adaptable to take on other shapes if desired. An edible support made of a non-malleable comestible, can be used in this shape or other shapes. Support 70 supplies two handles to the user, one for each hand. The portion within confection 84 is coated with barrier 86 which acts like an edible glue and holds the loops of malleable support 70 in place as well as acting as barrier 86.

FIG. 11—Description of Horizontal Frozen Confection with Cylindrical Support

FIG. 11 illustrates frozen confection 84, supported by support 62. Support 62 extends through confection 84 and supplies two handles to the user. Support 62 is candy, a dense cookie, or a rolled stiff hollow cookie or pretzel 96 that is filled with another confection, such as caramel,(or other suitable comestible) which is then dipped in barrier 86, or the ingredients may be reversed. Support 62 is shown with mess guard 76 on the ends, one for each hand. Other shapes and sizes of support 62 can be used.

FIG. 12—Barbell-Shaped Frozen Confection

FIG. 12 shows a barbell-shaped frozen confection 84 supported by support 62. Support 62 extends into twin frozen confections 84 at either end and supplies a handle in the middle of confection 84. Confection 84 easily offers two different kinds of frozen confections and different flavors. A mess guard 76 is provided in the center for the fingers.

FIGS. 13A-D—Description of Edible Tapered Supports for Frozen Comestibles

FIGS. 13A-C illustrate a tapered support 72 that can be either support 62 or support 60. A tapered shape permits an effective holding surface, depending upon the confection used.

FIG. 13A shows two additional fun ingredients 100 concentrically placed on support 72. Additional fun ingredients 100 provide a lollipop-type confection inside confection 84 for a triple treat. Support 72 can also have voids 66 in its upper end for durable adhesion of the comestible, as seen in FIGS. 15A-D. Support 72 may have a widened surface, a flattened surface, or both. These and other edible supports can be made in an opposite direction and be made wider than frozen comestible 84. In this case the edible support would protrude outside at least one outside edge of frozen comestible 84. A edible cross member can be supplied at the upper end at 90 degrees (not shown). A cross-section of the top of this cross member support would show an X shape.

FIG. 13B illustrates confection 84 positioned upside-down on a free-standing base. A single additional fun ingredient 100 is provided on support 72.

FIG. 13C shows a wider free-standing base. Edible mess guards 76 can be provided. FIGS. 13B-C are dipped in moisture-proof barrier, or chocolate coating 86.

FIG. 13D—Description of a Support Alignment Device

FIG. 13D is a support alignment device 118 which aligns a support during manufacture until confection 84 is frozen. Device 118 ensures that a frozen confection support is aligned properly in the desired position. This position may be horizontal or vertical or have other orientations. Device 118 may be edible or inedible. Materials for an inedible alignment device include paper, cardboard, plastic or any other suitable material. Materials for an edible alignment device include cookie, pretzel, wafer, ingredients etc., candy, a thickened and dried portion of pureed fruit, or other edible material.

Void 66 of device 118 may have fewer or more sides than four and may be lengthened to include alignment for a series of ice cream pops that are manufactured simultaneously or a series of supports in a single confection. Device 118 may also have different sizes, shapes, colors, methods of aligning, etc. An edible protective drip guard 80 may be used as an edible alignment device.

FIG. 14—Description and Operation of a Confection with a Moveable Sleeve

FIG. 14 shows confection 84 inside a non-edible sleeve 104 that is supported by cylindrically-shaped, support 60. Confection 84 is pushed by the user in an upwards movement (sleeve 104 moves down) through non-edible sleeve 104, by support 60, which exposes confection 84 for consumption. Non-edible sleeve 104 can be replaced with an edible sleeve, such as a thick chocolate barrel, wafer, cookie, candy, or grain etc. coated with barrier 86 (at least the interior portion), for further enjoyment.

FIGS. 15A-D—Description of Edible Tapered Support with Protective Edible Drip Guards and Mess Guards

FIG. 15A shows tapered edible support 72, supporting confection 84. Support 72 is a composite support that has multi-ingredients. Support 72 has a nougat center 90 and a layer of thick caramel on top of it 88, which are both then dipped in chocolate. Support 72 is rectangular in shape in its lower portion and flattened and square-shaped in its inserted portion, inside confection 84, for improved adhesion of confection 84 to support 72.

FIG. 15B illustrates support 72. Extra voids in the upper end of support 72 gives even more adherence of confection 84 to support 72. Support 72 also has an edible crumb mess guard 78 for the fingers. Support 72 can be dipped in barrier 86, crushed particles of cereal, cookie crumbs, candy bits, whole grains, and any other suitable crushed comestibles as mess guard 78 for the fingers. This keeps the fingers from coming in direct contact with support 72 (or any other edible support).

FIG. 15C is a picture of FIG. 15B with a protective, edible, drip guard 80 which helps to prevent the dripping of a frozen confection onto a consumer's hands or clothes. Drip guard 80 is totally edible and can be made of cookies, waffle, wafer, candy, grain flour, or any suitable comestible, even a platform or tray of thick chocolate. Covering drip guard 80 with barrier 86 keeps a cookie-type mess guard crisp. Edible drip guard 80 is adapted to take on any size or shape and is attachable to, or part of, any of the edible supports of this invention.

FIG. 15D shows FIG. 15C supporting confection 84.

FIGS. 15A-15D—Manufacture and Use of Edible Tapered Support with Protective Edible Drip Guards and Mess Guards

FIG. 15A shows edible tapered support 72 which is a composite support. Support 72 has two different ingredients nougat 90 and caramel 88 which are dipped in barrier 86, as noted above. Support 72 is rectangular outside of confection 84 and becomes wider and thinner where inserted in confection 84. Voids 66 in the upper end of support 72 (FIGS. 15B-D) reach from front to back and allow confection 84 to flow through to adhere the front of confection 84 to the back of confection 84. This helps keep confection 84 from falling off support 72, while it is being eaten.

An edible drip guard 80 is supplied in FIGS. 15C and 15D. Drip guard 80 is attached to support 72. Drip guard 80 catches any melting confection 84 which can be sipped from the side, corner or predetermined place of drip guard 80. Drip guard 80 can be any shape, such as square, rectangular, conical, circular, octagonal, flat, tray shaped, etc. Drip guard 80 is any needed thickness and made of any suitable comestible. FIGS. 15B-D show support 72 dipped into crumb mess guard 78, such as cookie crumbs, crushed candy, sprinkles, nuts, etc. to keep the fingers from melting coating 86 and to keep them clean.

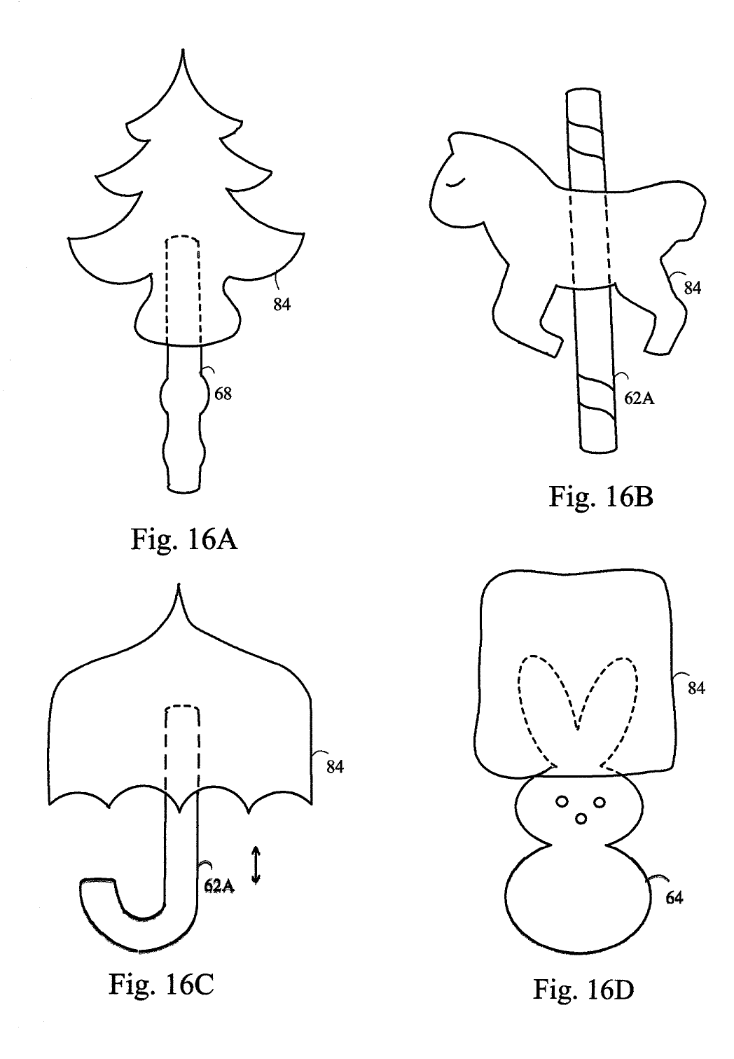

FIGS. 16-19—Description of Edible Animated Supported Comestibles

FIG. 16A illustrates confection 84 in the shape of an evergreen tree supported by support 68, which is the trunk of the tree.

FIG. 16B shows support 62A holding a pony-shaped frozen confection 84. Support 62A can be a combination of two or more sticks, from top to bottom, that can be twisted or attached together for a variety of flavors and appearances, such as the candy sold under the trademark The Wizard of Oz Kansas Twisters by Hollywood Partners, Inc. of Los Angeles, Calif. Candy streamers of shoelace licorice, dried fruit puree strips, etc., may stream out of the top of support 62A, as an edible Maypole. These streamers may be added to support 62A, after it is made with an edible glue, such as a royal cookie icing that hardens, or placed in the upper end of the mold that creates support 62A so it is embedded in the top end of support 62A during manufacture.

FIG. 16C is umbrella-shaped confection 84, supported by an umbrella handle-shaped support 62A. FIG. 16C can be hung upside-down from a freezer shelf, if frozen, or from a bakery rack, if non-frozen, for retail display or other use. Support 62A supplies a hanger for display and a handle for consumption.

FIG. 16D—Description of a Safe Confection for a Toddler

FIG. 16D illustrates an example of a very inexpensive, safe, and edible supported frozen confection especially for a toddler (or anyone). A seasonal, soft, marshmallow bunny, free form support 64, customarily sold in the United States in the spring, serves to support frozen confection 84, which is sold under the trademark Just Born. Marshmallow bunnies 64 are approximately two and a half inches long, an inch wide, and three quarters of an inch thick, and sold in a flat package of sixteen bunnies. These bunnies are covered with granulated sugar crystals that are colored and flavored. Pink and yellow bunnies have been traditional favorites, although now other colors are available. The shape of the bunny is made so that approximately one third of the marshmallow bunny is its ears. These marshmallow bunnies can be placed in the freezer and frozen, for use as edible supports.

When the bunnies are frozen the ears of the bunnies can be inserted upside down into a small cup, such as a four ounce cup of softened ice cream, one bunny per cup. The bunny and the small amount of ice cream is then put back into the freezer (the bunny is upside-down in the freezer) until the ice cream is totally set. When both are frozen, the ice cream with the bunny handle (remaining two-thirds of the bunny) is removed from the cup for consumption. This is a very safe treat for a toddler.

The body of the bunny is the handle and is used until the ice cream is consumed. The bunny's ears can be eaten simultaneously with the ice cream or after the ice cream is finished. The bunny slightly softens around the edges while confection 84 is eaten and is stiff in the middle. Bunny support 64 is easily eaten after the ice cream is finished. The confection benefits if the sugar is removed from the ears, but this is not essential. Doing this gives a firmer hold of confection 84 to bunny support 64. The ears of the bunny may also be coated with barrier 86. Snowmen, a Santa Claus, popular cartoon characters, and other marshmallow characters are used for other times of the year.

Another candy capable of supporting a frozen confection 84 is sold under the trademark Chocolate Covered Marshmallow Santa Treats sold by Melster Candies, Inc of Cambridge, Wis. The Santa Treats are elongated and are readily used as supports for confection 84. These safe frozen confections can be very easily and inexpensively manufactured and wrapped for commercial sale. If the toddler falls, they will not be injured by the confection, as opposed to a serious possible injury from a wooden stick.

An elongated marshmallow rod or stick made of twisted colors and/or flavors of marshmallow (not shown) can be frozen and easily used to support a frozen comestible, to delight a child. One such confection is made by Hollywood Partners of Los Angeles, Calif. and sold under the trademark The Wizard of Oz—Kansas Twisters (as mentioned in FIG. 16B). The Kansas Twisters, when made longer and frozen, support confection 84. Many other combinations like these are possible, for an edible supported confection or comestible. Traditional marshmallows made in fun shapes are frozen and used as edible supports. Edible supported confections, according to this invention, are adapted to be made in many, many different shapes and sizes, and are not to be thought of in terms of only traditional upright frozen (or non-frozen) pops on a stick.

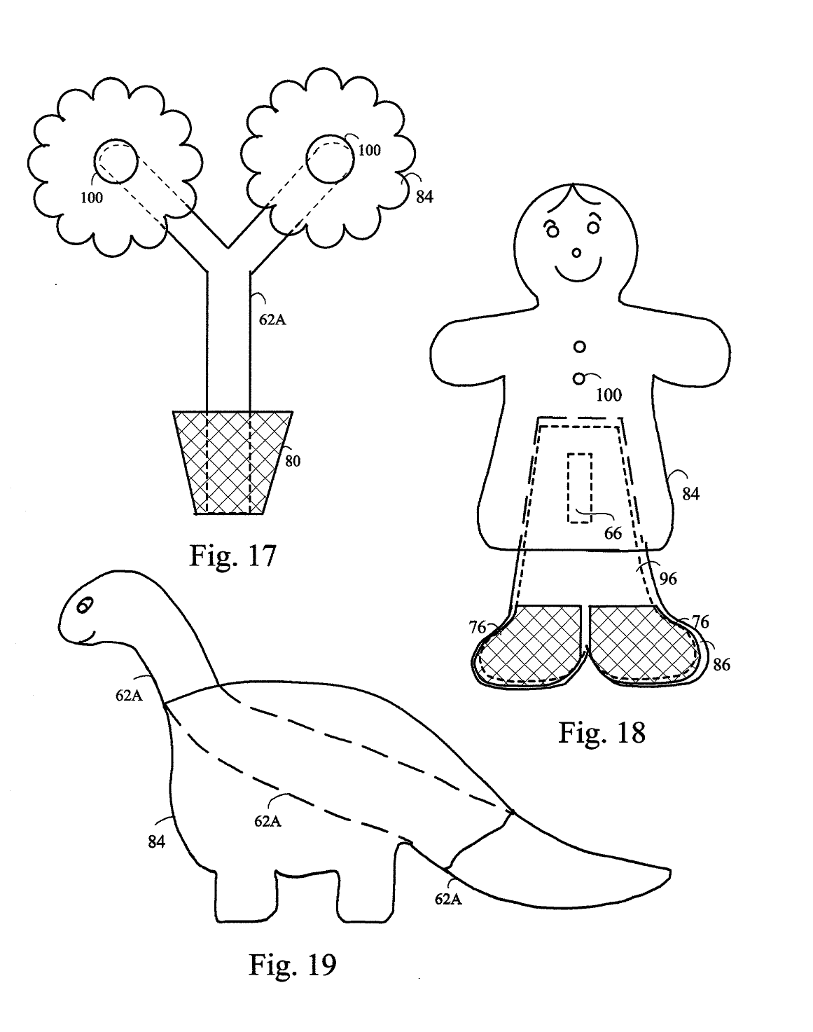

FIG. 17—Description of a Flower-Shaped Confection

FIG. 17 shows a flower-shaped confection 84, supported by a Y-shaped edible composite support 62A. FIG. 17 has two confections 84 which may be the same confection or different confections or flavors. Confection 84 has additional fun ingredients 100, such as candy, as the center of the two flowers. Drip guard 80 is provided at the base of support 62A. Drip guard 80 may be differently shaped or moved upward to allow room to grasp support 62A from underneath drip guard 80.

FIG. 18—Description of a Gingerbread Man-Shaped Frozen Confection

FIG. 18 shows a gingerbread man-shaped frozen confection 84, supported by dense cookie support 96. Support 96 is a sufficiently thick, dense cookie in the shape of legs, covered with chocolate coating 86. The feet or boots are mess guard 76, which were placed on support 96 after the cookie was dipped in chocolate but before the chocolate set or dried. Support 96 is pictured with void 66 for stronger adherence of frozen confection 84 to support 96. Additional fun ingredients 100 are used to depict features and clothing fasteners. Support 62 or support 60 are adaptable to be used here. Support 96 serves as a handle.

FIG. 19—Description of a Dinosaur-Shaped, Frozen Confection

FIG. 19 shows frozen confection 84, in the shape of a dinosaur, supported by support 62A. Support 62A passes through the frozen dinosaur body, confection 84, as an “edible spine.” The head and the tail provide two handles for the user, one for each hand.

FIGS. 16A-C and FIGS. 17-19 can easily be used for frozen or non-frozen comestibles. They can additionally be used for decoration, such as, if the supported comestibles are placed on the top of a cake. Supports 62A are used as handles in FIGS. 16A-C and FIGS. 17-19.

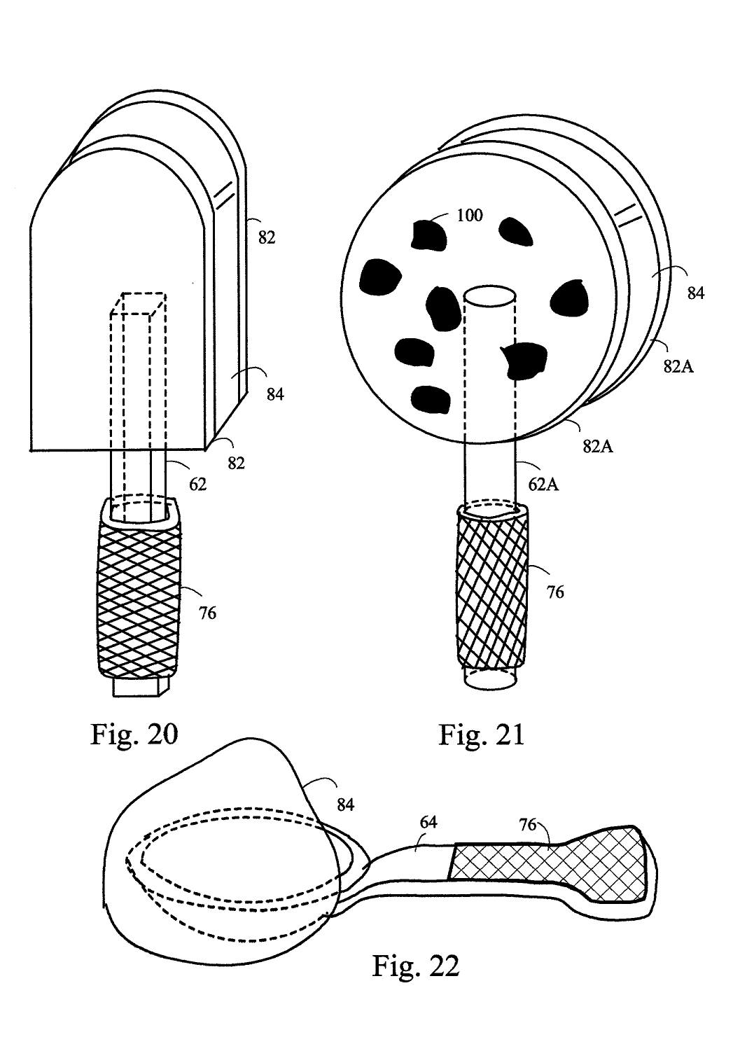

FIG. 20—Description of Ice Cream Sandwich Supported by An Edible Support

FIG. 20 illustrates a traditionally shaped confection 84 that has sandwich cookies 82 on the front and back of confection 84. Confection 84 and sandwich cookies 82 are supported by support 62. Frozen confection 84 is equipped with edible wafer mess guard 76 for the fingers. Sandwich cookies 82 are coated with barrier 86 where needed (not shown).

FIG. 21—Description of a Chocolate Chip Ice Cream Sandwich Supported by an Edible Support

FIG. 21 shows confection 84 having large chocolate chip cookies 82A, on the front and back of confection 84. Sandwiched confection 84, 82A is supported by cylindrical-shaped, edible composite support 62A. Support 62A has mess guard 76 on its lower portion. Sandwich cookies 82A benefit from being coated with barrier 86 (not shown). Confection 84 and sandwich cookies 82 and 82A may also be entirely dipped in coating 86 for a more luscious dessert. A confection made with cake and ice cream is adaptable to being supported by support 62A (or other supports).

FIG. 22—Description of a Spoon-Shaped Edible Support

FIG. 22 illustrates frozen confection 84, supported by a spoon-shaped, edible free form support 64. Support 64 supports ice cream, frozen pudding, frozen sorbet, frozen gelatin and many other frozen confections. Support 64 may be dipped in moisture-proof barrier 86, to seal out moisture. This frozen treat on an edible spoon (or other shapes) is also be used to administer mild tasting medicine to children which is mixed in confection 84 or support 64. If used in this manner, it would be necessary to put this in child-proof packaging with instructions and labeled with medicine icons for a child's understanding. Support 64 is adaptable to be made as support 60, support 62 or other edible supports. Support 64 serves as a handle and has mess guard 76 on its handle.

FIG. 23—Description of Edible Supported Frozen Confection and Packaging

FIG. 23 shows confection 84 supported by edible composite support 62. Support 62 has an added confection 100, such as fudge, caramel or peanut butter, that is flattened around the inserted end of support 62, giving support 62 more surface area for holding confection 84. Support 62 has a non-edible mess guard 110 on its lower end within supportive packaging 112. Inedible mess guard 110, such as bubble wrap, thin Styrofoam, paper, plastic, aluminum foil, etc., can be used instead of, or in combination with mess guard 76. Protective packaging 112 is made for individual servings, as illustrated, or for family sizes or commercial packages(not shown).

FIG. 24—Description and Operation of Disposable “All in One” Manufacturing Mold and Packaging Apparatus for Frozen Confections

FIG. 24 shows protective packaging apparatus 112 that has been inverted and fitted inside with a stiff paper or cardboard disposable mold 120, into which frozen confection 84 is directly poured. Mold 120 can also appear as a shapely Italian Ice cup with an edible support inserted in it.

Disposable mold 120, part of protective packaging 112, is a disposable mold, which is secured by (or part of) packaging 112. Packaging 112 may be stabilized by machinery during the manufacturing process. In a first step, the interior of mold 120 may be first sprayed with a wax coating, Styrofoam, non-stick vegetable spray, (or other smooth material) or provided with a wax paper (or other) sleeve (not shown), which facilitates the confection's releases from mold 112.

In a second step, coating 86 is sprayed to coat the inside of mold 120, or paper sleeve, etc. This provides a chocolate (or other) coating over confection 84. Several spraying intervals may be made, depending on the desired thickness and/or flavors of coating 86.

In a third step, confection 84 is poured from the top into mold 120 to a predetermined level.

In a fourth step, edible composite support 62, or any support, and drip guard 80, used as aligning device 118, is then inversely inserted into mold 120 at a beneficial time during manufacturing. Edible drip guard 80, or aligning device, 118 (FIG. 13D) are sized to fit the top of mold 120, which aligns support 62. Drip guard 80 is a bit wider and leaves room for dripping later on. Drip guard 80 or device 118, keeps the edible supports vertical, or in place until confection 84 is frozen and can keep the edible support(s) in place by itself. Stick alignment device 118 may have downward or upward flanges and preferably is designed as part of disposable packaging 112, such as a stiff paper, which can be left on until the consumer takes it off to eat the ice pop, or is designed as manufacturing equipment, which is reused.

To open the ice pop, tab 112A (or two or more pull tabs) shown on the side of packaging 112 is pulled out and around towards the rear of packaging 112, along perforated lines. This tears the four sides of the middle portion of packaging 112 off in one piece to unwrap the ice pop. The top of the container is then removed, and the ice pop is then lifted out of the mold 120 by support 62, mess guard 110, and drip guard 80, which is already there and ready to catch any drips from confection 84. The wax paper sleeve is taken off.

Edible drip guard 80 (FIG. 15C, 15D, 24), which catches the drips from melting confection 84, is easily used as device 118, because it can hold the edible support in position until confection 84 is totally frozen and eaten. Drip guard 80, and support 62 are fitted to size and inversely inserted into mold 120, and put in the freezer to freeze. When released from mold 120, by the consumer, the entire confection can be eaten, including support 62, drip guard 80 (used as device 118), confection 84, and mess guard 76, or 78, if desired.

Disposable mold 120 can be made in different sizes and shapes, including a tubular design, akin to the design of the containers that hold buttermilk biscuits (in the USA) in a cylindrical cardboard container, in the refrigerated section of the supermarket. This design of mold 120 preferably is constructed of a piece of thick paper, cardboard, etc., that is constructed as a spiral form or mold, leaving an opening at the top to pour the comestible and provide a rim for aligning the edible support. An even thinner paper can be wrapped several times around itself to create a mold durable enough for a frozen confection. An identifiable tab for the fingers is provided to start the peeling or removal process. A disposable mold that is not unraveled for opening may also be used, such as a push-up pop design, or a lift out design. Disposable mold 120 can be separated from protective packaging 112 for unwrapping.

In another method for unwrapping the frozen confection, a rectangular disposable mold 120 is previously sprayed or supplied with a releasing coating, such as wax, a wax paper sleeve, a freezer paper sleeve (or the like). To remove the ice pop, the outside seal of packaging 112 is removed near the bottom. The upward sides of packaging 112 extend slightly beyond confection 84 and two of the opposing or adjacent sides can be gently squeezed at a time to release the ice pop. This motion makes the front and the back of packaging 112 arch, or bow out a little. This releases confection 84, which may be covered with a wax paper sleeve. The ice pop support and confection 84 is then released through the bottom of packaging 112, into the consumer's hand. These designs provide a disposable mold and packaging, all in one.

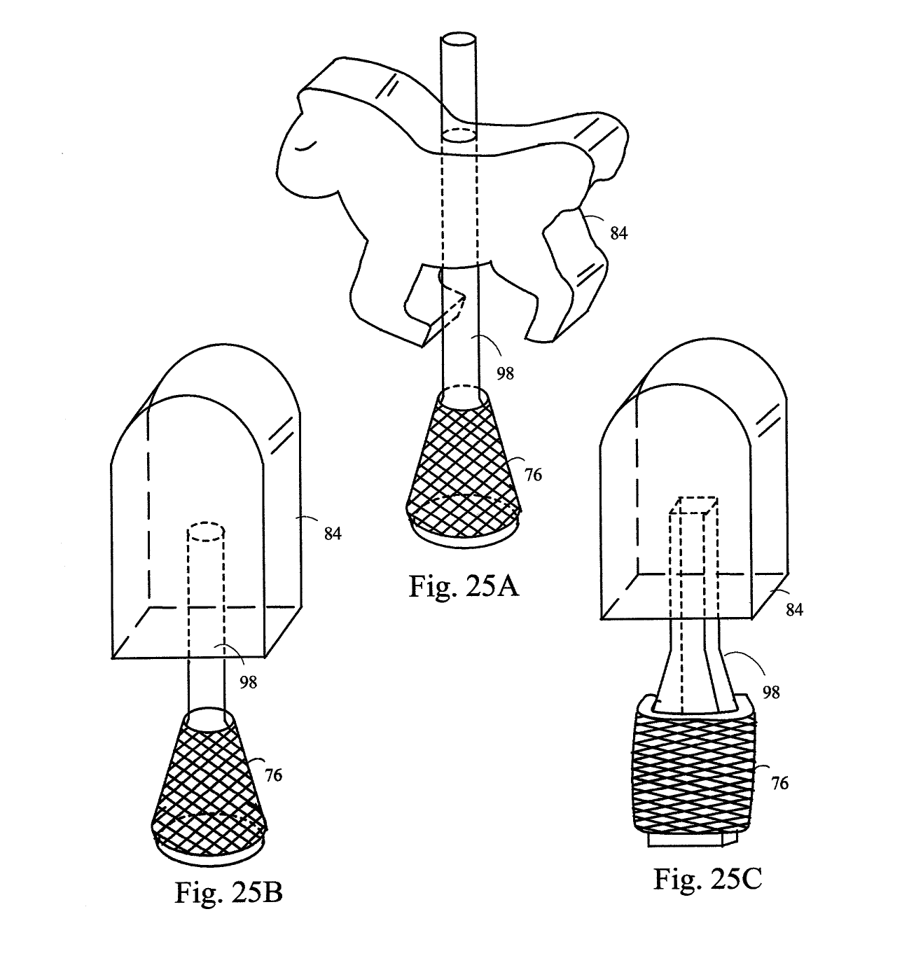

FIG. 25A—Description of Freestanding Carousel Confection

FIG. 25A shows a carousel-type horse, frozen confection 84 that is supported by an edible free-standing support 98. The base of support 98 is sufficient to hold confection 84 upright. Support 98 has mess guard 76 around its base. This frozen confection may be placed on a child's plate at a birthday party or briefly on a cake if the supported confection is frozen. If the confection is not frozen, it (or a series of them) may be placed on a cake first for decoration and then used for consumption.

FIG. 25B—Description of Freestanding Traditional Confection with a Cylindrical Support

FIG. 25B shows a traditional ice pop-shaped frozen confection 84 with a cylindrical, edible, free-standing support 98. Support 98 is equipped with mess guard 76. Support 98 allows the ice pop to stand on a level surface.

FIG. 25C—Description of Supported Traditional Confection

With a Square Base

FIG. 25C illustrates a traditional ice pop-shaped, confection 84, a rectangular-shaped support 98 and mess guard 76. FIGS. 25A-C will stand by themselves on a flat surface if the user has to briefly tend to a child or another matter.

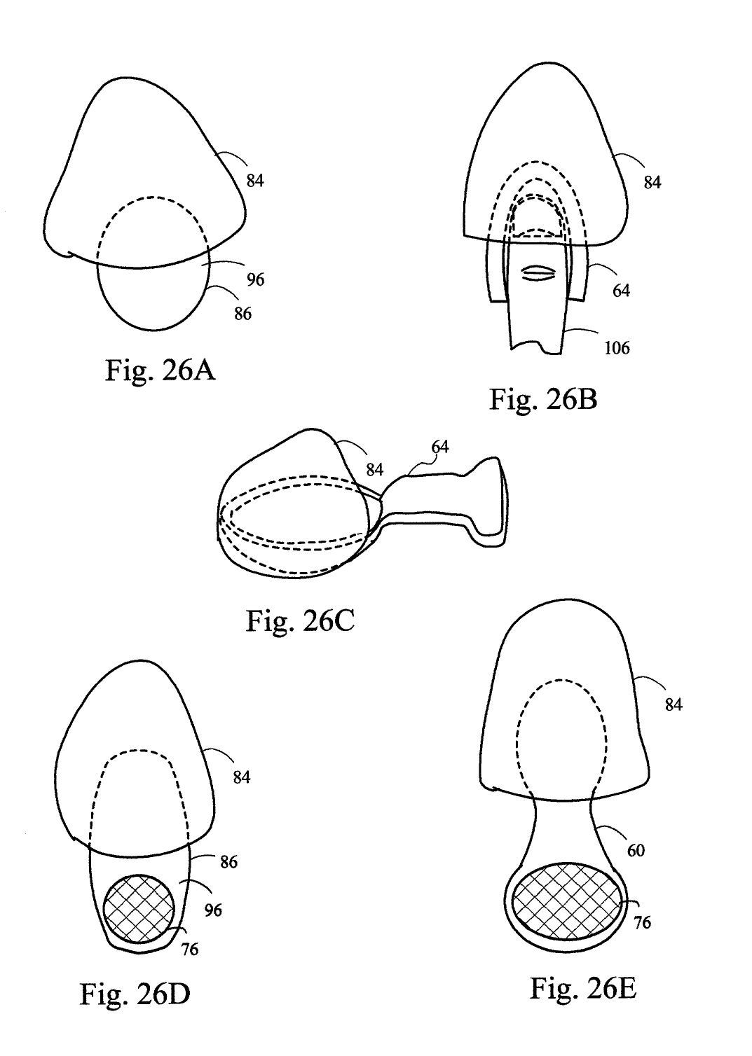

FIGS. 26A-E—Mini-Servings with Edible Supports and Mess guards

FIG. 26A shows dense cookie 96, covered by coating 86, such as chocolate, supporting a small amount of confection 84. This provides a treat for a person who feels like having a frozen confection, but not a lot of calories. It can be made of wholesome ingredients, such as a whole wheat cookie 96, covered in yogurt coating 86, with frozen yogurt or pudding 84. A circular, mint, chocolate covered cookie sold under the Trademark Thinmints by The Girl Scouts of America, efficiently serves to support confection 84.

FIG. 26B illustrates a hollow, edible free form support 64 that can be placed on a finger to be eaten. Support 64 supports a small amount of confection 84.

FIG. 26C illustrates a smaller version of FIG. 22, which is support 64 in the shape of a spoon, and a small amount of confection 84 around the spoon.

FIG. 26D shows an elongated dense cookie 96, covered by barrier 86, supporting a small amount of confection 84. On the bottom center, a disc of wafer is provided as mess guard 76. Any shape or size dense cookie 96 may be used.

FIG. 26E is similar to FIG. 28D but has a edible support 60 with mess guard 76 and a mini-serving of confection 84. Any shape support 60 may be used.

FIGS. 27A-E—Description of Cross-Sections of Edible Supports

FIG. 27A shows a cross-section from top to bottom of a dense pretzel 116 that is covered with barrier 86, such as a dried yogurt coating.

FIG. 27B shows a lengthwise, cross-section of edible composite support 62 made of dense cookie 96, and a thick covering of caramel 88 which is covered with barrier 86, such as the cookie bar sold under the trademark Twix (above) by Mars, Incorporated of Hackettstown, N.J. Support 62 can be inserted into softened, confection 84 either in a frozen or unfrozen state. An additional layer of caramel may be supplied to the bottom of the Twix (or similar) bar before being dipped in barrier 86.

FIG. 27C shows a lengthwise cross-section of support 62, which is made with a combination of caramel nougat 88 and nuts, or rice 94(or the like), and covered in barrier 86, such as chocolate, such as those sold under the trademarks Baby Ruth and 100 Grand, both by Nestle, Incorporated of Glendale, Calif. These candy bars provide a tasty and strong support when slenderized (or even left as is) and inserted in confection 84.

FIG. 27D shows a lengthwise, cross-section of support 62. A chocolate nougat center 90, topped with a thick layer of caramel 88 and covered with coating 86, makes a sturdy support 62, such as the candy bar sold under the trademark Milky Way Bar, also by Mars, Incorporated of Hackettstown, N.J. This is a familiar and delicious combination and makes an excellent support for confection 84.

FIG. 27E shows a lengthwise, cross-section of support 60 having a dense marshmallow candy 92 (homogenized), which has been dipped in coating 86, such as the candy bar sold under the Trademark Charleston Chew, by Cambridge Brands, a subsidiary of Tootsie Roll Ind., Inc. Charleston Chew comes in a variety of flavors such as vanilla, chocolate and strawberry. Tootsie Roll also makes a fudge candy which is sold under the trademark Tootsie Roll. This candy is suitable as malleable support 70. An elongated, chocolate covered marshmallow Santa Claus candy sold under the trademark Chocolate Covered Marshmallow Treats by Melster Candies, Inc. of Cambridge, Wis. (similar to support 64 in FIG. 16D) is easily inserted into softened confection 84 and then frozen, creating a very inexpensive, edible stick supported confection.

FIG. 28—Description of Homogenous Supports

FIG. 28, also illustrated in FIGS. 3 and 4, shows support 60, shown in a conventional ice pop stick shape (the usual shape of a wooden stick). Support 60 is a durable, edible support for supporting frozen and non-frozen comestibles. Such a stick is the candy sold under the Trademark Lik-a-maid by Sunmark, Inc. of St. Louis, Mo., as mentioned in FIGS. 3 and 4, above. It can be coated with coating 86, if desired, especially where inserted in confection 84, for a longer lasting shelf life. Mess guards 76, 78 are not needed for the fingers as support 60 does not melt easily.

FIG. 29—Description of Sandwich Cookie Support

FIG. 29 shows support 62 which has two sandwich cookies 82, and a sandwich filling 113. Filling 113 can be made of any thick filling such as the conventional, cookie-creme filling, fudge, peanut butter, or even a small amount of ice cream. Support 62 is dipped in chocolate coating 86 and has edible mess guards 76 on the lower portion of the front and the back. The upper half of support 62 is inserted into confection 84 and both are frozen to make a totally edible supported confection.

FIG. 30—Description of Dense Cookie Support

FIG. 30 is dense cookie support 96, that has a small circular topping of additional fun ingredient 100, such as peanut butter, which is placed over support 96. Support 96 is then covered with coating 86, such as chocolate, such as the cookies sold under the Trademark Tag-a-longs by The Girl Scouts of America. Support 96 is then topped with confection 84. A circular candy sold under the Trademark York Peppermint Pattie by Hershey Foods Corporation of Hershey, Pennsylvania is also adaptable to support confection 84. Almost any candy or cookie that has coating 86 and is sufficiently rigid will support confection 84. Edible supports are not restricted to any size, length, shape or thickness.

FIG. 31 is cross-section of one version of support 62 which has a central core of dense cookie 96, covered in caramel 88 and dipped in barrier 86. A popular snack that is sold under the Trademark Combos by Mars, Incorporated of Hackettstown, N.J., is a dense hollow length of pretzel with a cheese filling inside. Combos (or similar confections) support confection 84, if they are elongated and protected with barrier 86, such as a white yogurt coating, often used as a coating on small twisted pretzels.

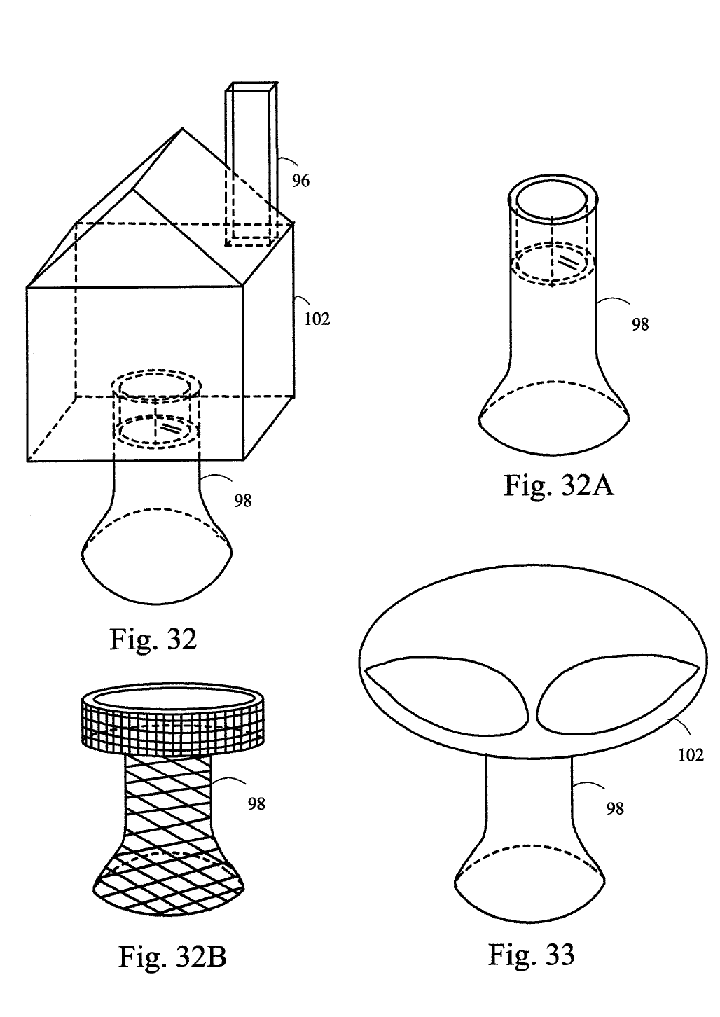

FIG. 32-43—Description of Non-Frozen, Supported Comestibles

Some examples of traditional, non-frozen, supported, comestibles are lollipops, rock candy on a stick, cookies on a stick, corn dogs on a stick, cotton candy, hors d'oeuvres on a skewer, and coated fruit on a stick.

Non-frozen comestibles are sometimes put on a stick. These sticks are usually made of rolled paper or wood. Lollipops are usually put on a tightly rolled piece of paper. Cotton Candy is usually put on a piece of paper loosely rolled into a cone shape. Cookies, rock candy, corn dogs and dipped or coated fruit are usually placed on a wooden stick. None of these supports adds to the flavor of the confection or serves to make the confection last longer.

An embodiment of this invention discloses a new combination and way of eating comestibles. Cupcakes, cereal with marshmallow, caramelized popcorn, brownies, cookies, etc., that are not ordinarily supported are supported, with edible supports, making new, delicious and eye catching confections. Confections, like a gingerbread man-shaped fudge brownie (dipped in chocolate—optional) are placed on a favorite candy bar support and frozen for a novel rich treat. Lollipops, cookies, necklaces, bracelets and rings, are supported and totally edible.

FIG. 32—Description of a Supported Tree Fort Cupcake

FIG. 32 shows a tree fort-shaped cupcake, or non-frozen confection 102. Confection 102 is supported by an edible free-standing support 98. Support 98 is preferably made of wafer or sugar cone cookie ingredients, regular cookie ingredients, pretzel ingredients, candy or any other suitable comestible. The upper end of support 98 is hollow for better adherence with confection 102, but is not necessary. The roof of confection 102 is equipped with a chimney, or dense cookie 96. This chimney can also be made with a rectangle of candy, stack of candies, a pretzel, or any other suitable comestible or confection 100. Confections 100 can be added to decorate confection 102, depicting doors, windows, railings, and even a rope ladder of shoelace licorice.

FIG. 32A is support 98 shown for clarity.

FIG. 32B is support 98 with a wider top, for stabilizing a larger comestible. Support 98 shows wafer or sugar-cone like ingredients. Support 98 can be constructed in many shapes and sizes.

FIG. 33—Description of a Festive Cupcake

FIG. 33 shows a child's festive cupcake, in the shape of an alien, or non-frozen confection 102. Confection 102 is supported by edible, free-standing support 98, as pictured in FIGS. 32 and 32A. Support 98 can be constructed of an edible ice cream cone that is turned upside down and inserted into confection 102, (or frozen confection 84)(not shown). The inserted portion of edible support 98 is dipped in barrier 86 to keep this portion of support 98 crisp and strong. Confections 100 can be added to provide eyes, antennae etc., for the alien. A great many other shapes, sizes and ingredients of support 96 and confection 102 are adaptable for manufacture. Support 98 is used for display in this figure.

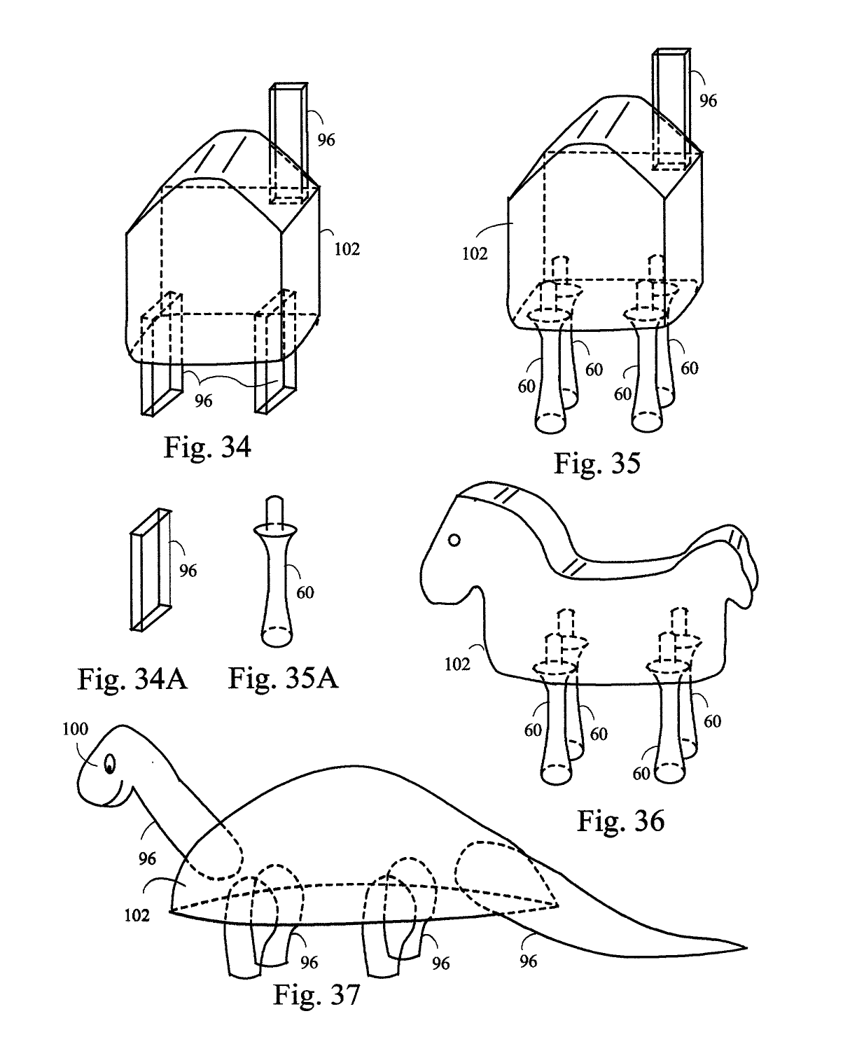

FIG. 34—Description of Tree Fort Cupcake Supported by Cookies

FIG. 34 shows another way a child's festive cupcake can be made. Confection 102 is the shape of a tree fort, supported by two dense cookie supports 96. Supports 96 are strong cookies like rectangular graham, ginger, mint cookies (or other). Support 96 is used as a support for display in this figure.

FIG. 34A pictures dense cookie 96 by itself. Graham, mint, ginger cookies or other cookies, are used to support confections 102 and 84. Cookies 96 can be covered in chocolate, etc., but is not necessary.

FIG. 35 is similar to FIGS. 32 and 34, both tree forts. However, confection 102, is supported by peg-like legs, support 60. Support 60 is preferably constructed of candy, such as FIG. 28, cookies, pretzels, or the like.

FIG. 35A is an individual illustration of support 60 in FIG. 35, shown for clarity. The upper rim of support 60 may be much wider.

FIG. 36—Description of a Festive, Horse-Shaped Confection

FIG. 36 shows non-frozen confection 102, such as a cupcake, in the shape of a horse. Four supports 60 when inserted into the horse-shaped cupcake allows the horse to stand. Two X or H-shaped supports (or other shapes) can be used in place of four individual supports 60. Four supports 60 may be joined together. Additional fun ingredients 100 can depict features, such as eyes, mouth, saddle, and a mane. A checkered square of dried fruit puree, such as the popular snack sold under the trademark Fruit by The Foot, by Betty Crocker distributed by General Mills, Inc. of Minneapolis, Minn., or other confection, such as cotton candy, etc., may be used as a blanket. Shoestring licorice may be used as a bridle and reins.

FIG. 37—Description of Edible Supported Dinosaur-Shaped Cupcake

FIG. 37 shows non-frozen confection 102, such as a cupcake or crisped rice cereal and marshmallow, in the shape of a dinosaur, made for children. The neck, tail and legs are made of dense cookie support 96. Pretzels, covered pretzels, candy, or other comestibles are easily used as well. Confections 100, used for facial features seem to give life to confection 102. Support 96 is used as a display in this figure.

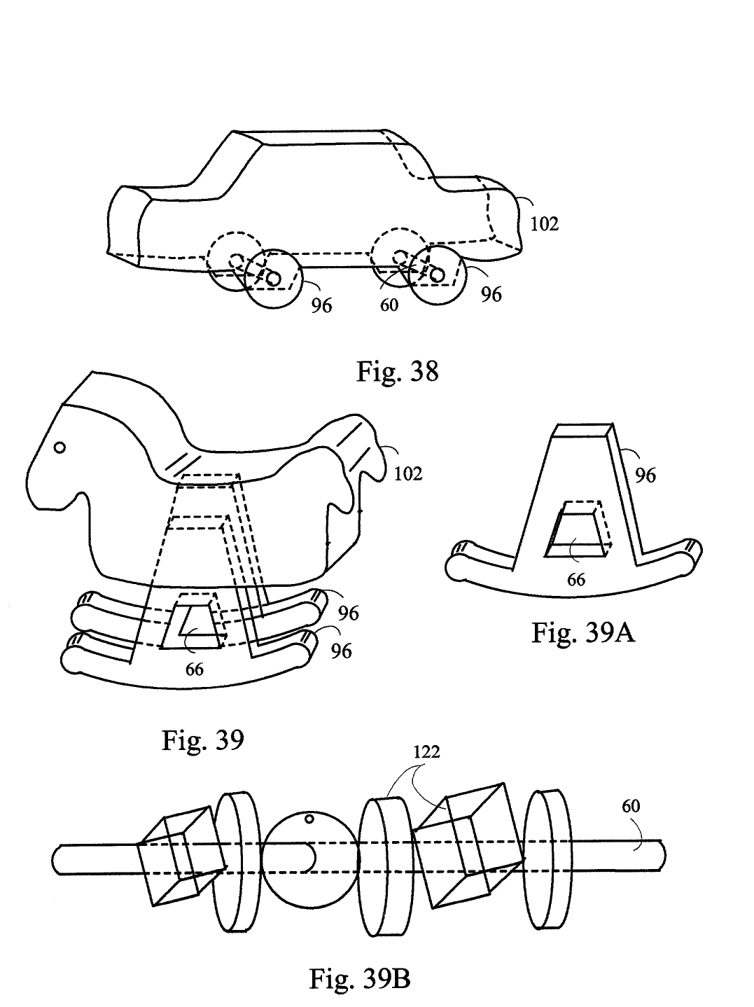

FIGS. 38—Description of A Working Edible Car Supported by Comestibles

FIG. 38 shows a totally edible, car-shaped confection that rolls. The body of the car is non-frozen confection 102, such as a cupcake. The axils, support 60, are preferably made of a dense pretzel rod, candy rod (ex. Lik-m-aid), cookie rod, or other stiff comestible. The wheels can also be specially made from discs of dense cookies 96, candy, carrots, pretzels, or other suitably made comestibles. Constructed this way, this car can roll a bit on a child's plate, giving them a pleasant surprise.

FIG. 39—Description of Functioning Rocking Horse Confection

FIG. 39 shows an edible rocking horse. Non-frozen confection 102 is the body of the horse. Dense cookie 96 is a specially shaped, dense cookie, that has been stamped with void 66 or molded and baked in the shape of the rocking portion of a rocking horse. Two identical dense cookies 96 are shown inserted in confection 102. This rocking horse can actually rock back and forth on a plate, bringing smiles to children's faces at a birthday party. The supported confection is totally edible and very inexpensive and easy to make. Dense cookies 96 are used as display supports in this figure.

FIG. 39A is a single, dense cookie 96, used in FIG. 39, shown by itself for clarity.

FIG. 39B—Description of Edible Skewer

FIG. 39B shows hors d'oeuvres on an edible skewer, or support 60. Support 60 is strong enough to pierce and support foods like cheese, meatballs, sliced meats, cherry tomatoes, olives and the like for tasty hors d'oeuvres or fruit for a fondue. Meatballs and other hors d'oeuvres can be displayed as well supported on a tripod of thin, stick-like pretzels. The entire hor d'oeuvre can be eaten, including support 60. Support 60 in the shape of little edible handles (or other shapes) (not shown) inserted deeply into the hor d'oeuvre can support the hor d'oeuvre. This saves wood that would be used in making toothpicks, that are traditionally used for hors d'oeuvres.

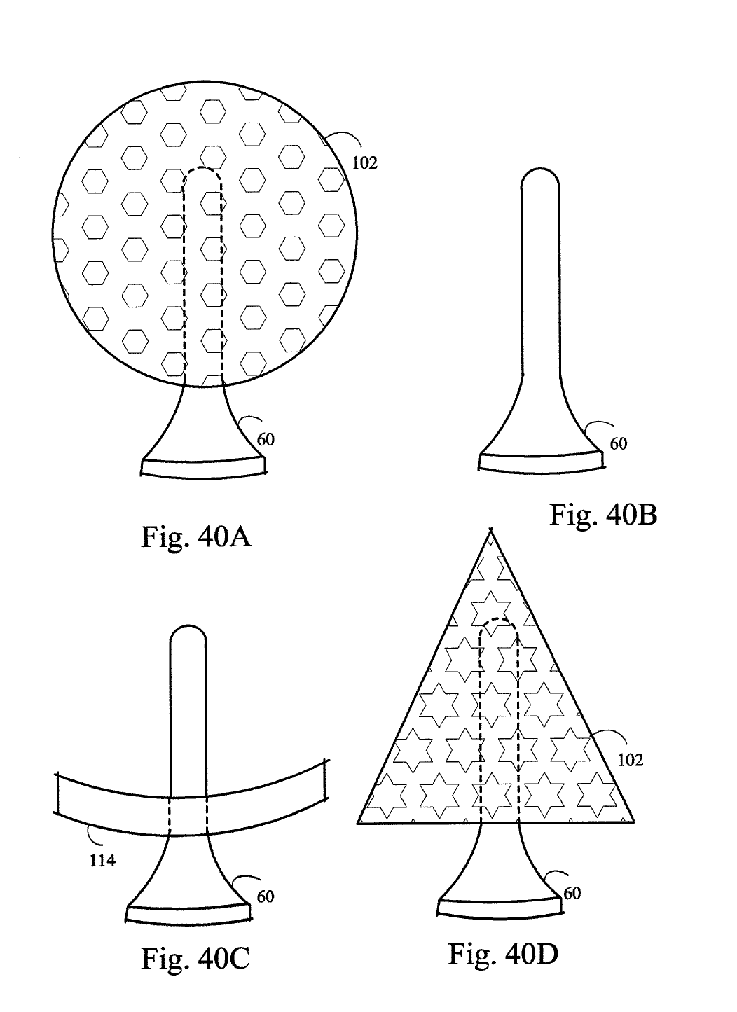

FIG. 40A—Description of Supported Golf Ball Confection

FIG. 40A shows non-frozen confection 102, in the shape of a golf ball. It is supported by a tee-shaped, support 60 as seen in FIG. 40B. Golf ball-shaped, confection 102 is made in two halves and “glued” together with icing. Confection 102 is placed on the supporting tee, support 60, and frosted. After the frosting has set a bit, a small blunt instrument such as a small wooden dowel (rounded at the tip)an edible dowel 60 (or the rounded tip of another edible tee, as seen in FIG. 40B) can be used to mark “dimples” in the icing of the golf ball. Support 60 is used as a display in this figure.

FIG. 40C shows support 60 with an additional edible end stop 114, which keeps confection 102 in place on support 60.

FIG. 40D shows confection 102 as a tree, supported upon tee-shaped, support 60.

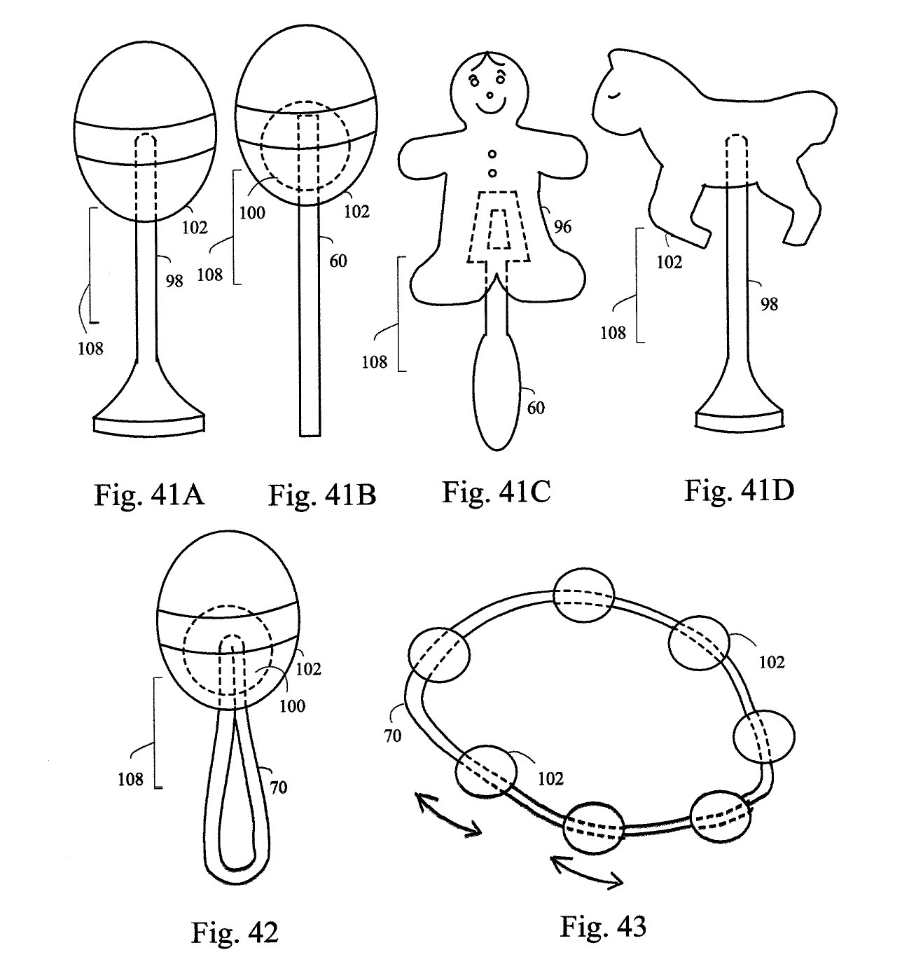

FIGS. 41A-41D—Description of Lollipops on Edible Supports

FIGS. 41A shows support 98 supporting lollipop confection 108. Confection 108 can be placed on a level surface if a child starts to eat it, but has to stop for a reason. This way it will not stick to a surface and can be finished.

FIG. 41B shows lollipop 108 is supported by support 60. Lollipop has additional fun ingredient 100 in its center.

FIG. 41C is dense cookie 96 in the shape of a gingerbread man supported by support 60. Additional fun ingredients 100 gives the gingerbread man a smile and clothing fasteners. Features and fasteners, etc. may also be etched in.

FIG. 41D shows pony-shaped lollipop 108, supported by support 98. This confection can be placed on a circular cake to depict a carousel for a young child's birthday party. The cake can be placed on a musical or plain revolving cake stand so the carousel cake seems like it is operational. Later lollipops 108 can be totally eaten.

FIG. 42A—Description of Lollipop on Malleable Supports

FIG. 42A shows lollipop 108 supported by edible malleable support 70, such as a length of licorice. Support 70 is first positioned in additional fun ingredient 100 which is then covered by lollipop 108 for triple treat.

FIG. 42B illustrates how a necklace or bracelet with bead-shaped candy, non-frozen confection 102 is made, supported by edible malleable support 70. Confection 102 beads are strung on support 70 and placed on the hand or neck. This necklace or bracelet can be totally eaten. Support 70 is used as a wearable support in this figure. A ring for the fingers can also be made in this manner.

FIG. 32—Construction and Use of Non-Frozen, Supported Edible Comestibles

FIG. 32 shows non-frozen confection 102, such as a cupcake, that is made with a two piece mold. The front of the fort is made with the front half of the mold and the back of the fort is made with the back half of the two piece mold. After baking, cooling and taking the cupcake out of the mold, the two cupcake pieces are glued together with icing. Edible skewers 60 may be inserted in the bottom from front to back for stability.

When the icing is set, support 98 is inserted into the bottom surface of non-frozen confection 102. Non-frozen confection 102 reaches an impasse in the center of edible support 98 and can go no further and non-frozen confection 102 is well supported. A tall, slender cookie or candy placed in the top, rear corner of the fort becomes the chimney. Additional fun ingredients 100, such as candies for the windows, doors, shutters, can be glued on with icing. A rope ladder can be made of shoestring licorice and hung from the fort.

FIG. 33 shows a confection that is constructed in much the same way as FIG. 32/, but the “alien” cake mold is made in “top” and “bottom” pieces, which are glued together with icing. Alien eyes are made with additional fun ingredients 100, such as dried green or purple fruit puree, gummy confections or icing, etc.

FIGS. 34, 35, 36, and 37 are made in a similar manner and edible supports 60 are pressed into the bottom surface of non-frozen confection 102. FIG. 38, a dinosaur, is supported with densely made cookie appendages 96. Icing, additional fun ingredients 100 or engraving in dense cookie 96 are used to create a face on the dinosaur.

FIG. 38 shows non-frozen confection 102 in the shape of a car. Confection 102 is made with a two-piece cake mold, preferably front and back pieces. The two axils of the car are support 60 which pass through two convex arches of confection 102 on the car's underside. The wheels are dense cookie 96, which have void 66 in the center. They are placed on the axil, support 60. This car when constructed, can actually roll on the plate. Dense cookies 96 are used as display supports. The windows, doors, windshield, bumpers, lights, etc. can be made with additional fun ingredient 100.

FIG. 39 shows non-frozen confection 102, such as a cupcake, in the shape of a horse, which is made with a one or two-piece cake mold. Confection 102 is supported with two supports 96. Supports 96 are made in the shape of rockers which are inserted in through the bottom of the confection 102. When constructed, confection 102 can actually rock back and forth to delight a child.

FIG. 40A shows golf ball-shaped non-frozen confection 102 on a tee, supported by support 60 which is inserted into the bottom of a cake ball, made with a two-piece mold. Icing covers the ball and a rounded dowel is used to make the dimples in the icing. It is a very nice dessert after a golf outing. The golf ball can be filled with a small amount of whipped cream, ice cream, fruit, pudding, etc., if desired. Other theme balls can also be made such as, a baseball, football, soccer ball, basketball, etc., and put on an appropriately styled edible support. FIG. 40D, an edible tee as a trunk, is made with a one or two-piece mold and is supported by support 60. It can be decorated with icing and/or additional fun ingredient 100.

FIGS. 41B-41C lollipops 108 are supported by support 60. FIGS. 41A and FIG. 41D have edible standing supports 98. The free or non-standing end of support 60 is placed into a mold and non-frozen confection 102 is poured or pressed into the mold. When the non-frozen confection 102 is firm, lollipop 108 can be removed. Additional fun ingredient 100 may be placed into the empty mold previously to the pouring of non-frozen confection 102 or “glued” with a hardening cookie icing onto lollipops 108 after removal from the mold.

FIG. 42, lollipop 108, is supported by edible malleable support 70, such as licorice. The licorice is first inserted into additional fun ingredient 100. When this step is set, edible malleable support 70 and additional fun ingredient 100 are placed into a mold to receive non-frozen confection 102.

FIG. 43 is a bracelet made of candy beads supported on edible malleable support 70, such as licorice. Candy beads are strung on support 70. The ends of edible malleable support 70 can be secured with a non-moving candy bead. The ends of edible malleable support 70 can also be made adjustable by overlapping the ends and passing the two ends through a single candy bead, in opposite directions. The candy beads can be bitten off support 70 or taken off support 70 and eaten. Rings can also be made.

FIGS. 32-40D and 43 Can be Constructed as Comestible Kits

FIGS. 32-40D and 43 are adaptable to be specially made as “comestible kits” for use at home (or commercially) for birthday parties, celebrations, or for every day fun, such as after school snacks. A specially designed box can contain a two-piece (or other number) baking mold for several cupcakes (or frozen comestibles) to create the bodies of animals, cars, forts, rocket ships, etc. Also provided in the box are edible appendages [edible support 60, pretzels, dense cookies, 96] for the supported comestible, such as, legs for a horse, rockers for a rocking horse or wheels and axils for a car, etc. All the tools and instructions needed are provided in the kit for the construction of the specialized supported comestible. A reusable plastic tool or smooth wooden dowel is supplied in the kit to create the “dimples” in the golf ball confection, or frosting tips and an icing tube are supplied to make “fur” for an animal-type confection.

After the cupcake portion has baked and cooled, the two or more cupcake pieces are adhered with icing. The cupcake can then be either coated with icing or left as it is. Then the baker, (mom, dad, older child, etc.) can insert the legs, head, tail of the animal or footing for the fort, tee for the golf ball, etc., and place it on the plate. This is easily done and it makes an entirely new and fun dessert, especially for young children and for celebrations after sports activities.

Frozen Confection Kits

Kits intended for frozen confections are made easily as well. Separate components placed in a box at room temperature to construct a certain frozen confection provide easy-to-make and inexpensive kits. An appropriately decorated and shaped container containing a cup of vacuum sealed pudding (individual size) and an elongated candy bar in the shape of a stick. At home the stick is unwrapped and placed into the partially uncovered cup of pudding. The stick and the pudding is then placed in the freezer and becomes a frozen ice pop.

The container for the pudding has a sealed top with a window just large enough for the support which keeps the support aligned. This window is sealed in a second step during packaging, to keep the pudding airtight, (or perforations are made to provide a smaller initial opening). To construct the frozen confection, the user first peels off the square (or other shape) that covers the window on the larger seal, inserts the candy bar, and places it in the freezer. When the confection is frozen, the larger cover with the open window is removed up over the support and then the edible, supported frozen pudding pop is removed from the pudding container. Frozen and non-frozen confections and supports can have mini-colored or flavored chips in them, mini size pieces of individually coated (or non-coated) candies, crisped rice, nuts, etc., layers or swirls of different colors and flavors.

Summary, Ramifications and Scope

From the foregoing description the reader will see that I have provided many new and enjoyable edible supported comestibles for children and adults. As a frozen confection, my supported comestibles double the pleasure of eating a confection because it is two (or more) deserts in one. It is a frozen ice cream confection (etc.) as one would ordinarily find on a wooden ice cream pop stick plus a frozen candy bar (or the like) as a support, in place of the wooden stick, for a new and safe treat.

As a non-frozen confection, it replaces a dull cupcake with a delightfully displayed, edible rocking horse, an alien, a golf ball on a tee, a rolling car, and many many others. Brownies and cookies can now be eaten along with their edible stick and lollipops can be totally eaten. Traditionally non-frozen confections, such as brownies, are creatively shaped, placed on an edible support and frozen for an exciting, new taste experience.

Since the edible ice pop supports are frozen, from being in the freezer along with the ice cream, pudding, yogurt, or what ever confection it supports, it keeps the ice cream colder, longer and provides a wonderful and cooling second dessert. Since it is frozen, it lasts longer and it is a lot of fun to eat. The frozen edible stick with its cool temperature in the hand is a very welcomed feature, especially in the summer.

Being able to eat the support provides a longer lasting treat, eliminating the feeling that it was just not enough. These new edible supported comestibles solve this problem because the child or consumer has a frozen candy bar or cookie bar to eat as well, after the ice cream. This at least doubles the enjoyment of the confection. My edible supports solve a dangerous problem by replacing a potentially dangerous frozen supported confection on a wooden stick with a safe edible supported frozen confection. My edible supported pops are a truly enjoyable, safe, inexpensive, longer lasting, non-wasteful, confection.

The fact that the exterior of the candy bar or cookie bar is chocolate coated in an embodiment is not a significant problem. Because the candy or cookie bar is frozen, and frozen deep within, it has a tendency to keep itself cool from the inside out. It is a lot less messy than eating a regular candy bar in the summer. For a small child who has a tendency to grab the stick with all fingers and very tightly so, my edible mess guards made of thin wafers, or crushed comestibles, solve this situation and are a functional and effective addition to edible support sticks.

The wrapper of the ice pop may also be left on the end of the stick, together with an edible mess guard or instead of one, to prevent a possible messy situation. Leaving the wrapper on the end of the confection has been the natural tendency of consumers when they have been eating an unsupported ice cream square made of a slice of ice cream and thinly coated with a dipping of chocolate. My wrapper or non-edible mess guard, may be made of recycled or other paper, foil, thin Styrofoam, plastic, plastic bubble wrap or any other cost efficient and preferably environmentally compatible material.

Another benefit of my edible supported comestibles is that they do not have to exclude those who are allergic to chocolate or have a reaction to chocolate in any way. Edible ice cream pops are also made with malleable liquorice lengths, other confections such as marshmallow, toffee, granola, or a stiff peanut butter bar (only to mention a few, for example. Cookie, granola, etc., bars can be covered with yogurt, or white chocolate, which actually does not contain chocolate, for supporting a comestible. Edible supported confections are also made considering those who are calorie conscious and those who may not have sugar or dairy products.

My edible supports are not limited to edible supports made by established companies or to the ingredients mentioned. The edible support ingredients mentioned along with established companies above, are examples of successfully constructed, supported comestibles, that are easily recognizable for the reader, according to this invention. Any well made chocolate coating or fudge (or other flavor) over a sufficiently dense comestible of any kind will support a frozen comestible. A sufficiently dense comestible of any kind will support a non-frozen comestible. FIGS. 27A-27E (and others) are examples of how ingredients can be put together. Although the ingredients of the aforementioned companies work well, other ingredients and combinations of ingredients also work well.

My edible sticks and supported comestibles lend themselves to more than the usual upright designs. They can be made with a horizontal (or other) orientation and an edible stick extending out from both sides of the ice cream confection. Edible two-way supports can stand at either end of the confection if desired, like an hour-glass which is turned over on either end, or a multitude of ends, like a cube. A number of carousel horses, etc., on edible, two-way supports can hold one layer of cake above another layer of cake to construct a multi-tiered cake. Edible sturdy supports (such as support 60) take on any shape, such as the shape of a handle on a mug, which is inserted into a comestible to support a confection of cake, cookie, brownie or rice and marshmallow treat, etc., for consumption.

Edible supported comestibles lend themselves to whimsical and silly designs including using soft gummy appendages such as those sold under the trademark Gummy Worms by Frerrara Pen Candy Company of Fortes Park, Ill. to make a edible supported cupcake octopus, or an ice cream pop with twin, support 60 legs, with gummy worm arms and gummy worm hair (of a smaller diameter), or the like.

Support 60 may have a hollow center which may be filled with another confection such as a candy jell or fudge (or other). Edible support sticks may have several voids in different places, such as an edible support appearing like a ladder. An additional edible support(s) may be added to make a triplet pop instead of a twin pop, etc. Edible supported cupcakes with a theme, such as a cupcake ball can be disassembled (top portion is removed) to reveal an edible toy character inside for a child.

A coating of cookie crumbs, sprinkles, nuts, cereal, (whole or crushed, processed or whole grain), wafer-like cookies or cone material (dark or light) can be wrapped around or used to coat the area where the fingers hold the edible supported pop. These coatings are used as mess guards. Frozen confections 84, such as ice cream, pudding, yogurt, etc., can be dipped in sprinkles, chocolate, nuts, crushed candy, sprinkles, crushed cereal or grains, etc., or have a clear ice coating. Coating 86 may coat a sherbert or pureed fruit-type frozen confection.

Edible wafer segments, cupped candy or cookies, or other comestibles, that catch dripping from a frozen confection are used as drip guards. Drip guards protect clothing and keep small children from being upset if their confection starts to melt. Supports, mess guards and drip guards, can be covered or sealed with any suitable, moisture resisting edible substance.

Edible mess guards can be applied in any shape or thickness with additional edible glue, such as additional chocolate, white chocolate, yogurt, etc. Edible mess guards can be made of wafers, thin licorice squares, lines or rolled dried pureed fruit shapes, flat candy or gum discs, or any comestible that is serviceable. Protective mess guards and drip guards can be edible or nonedible.

My edible sticks and supports for non-frozen comestibles are used to make creative baking kits. These creative baking kits include cupcake molds in fancy designs, such as the body of a dinosaur, pony, halves of a golf ball, and others. Supports made of cookies, pretzels, candy supports, etc., are designed and included in the kit to be used as the legs, head, and tail of the dinosaur (or other). Several kinds of edible supports can be maneuvered, affixed or twisted or placed together to make a single support, such as licorice and marshmallow.

A lollipop and its stick are also totally eaten. A lollipop supported on a loop of licorice is a fun, inexpensive and safe treat. Edible supported lollipops may spin on edible supports as they do on non-edible supports in prior art. A cupcake, cookie or hors d'oeuvre on a support can be eaten, support and all. A necklace or bracelet made of a length of licorice and decorated with candy beads can be entirely eaten.

These edible supports can be made in a great many ways for a variety of purposes. Edible supports can be handles or supports that enable the comestible to stand on its own for a beautiful display or series of displays. An inverted ice cream cone can support a comestible from within the comestible. An edible cake golf ball on an edible tee, served at a golfer's dinner event for dessert is an unexpected surprise. These golf balls can be any size and filled with custard, ice cream, pudding, or the like. Little edible rocking horses or totally edible rolling cars made from comestible kits can be placed on a child's plate at a birthday party for smiles beyond words.

My edible supported comestibles can be very small for bite-size portions, medium size for individual portions, large for a special treat or extra large, for a large edible table display. Protective, edible mess guards and drip guards are provided in accordance with this invention, if desired, so that the consumer's fingers don't get messy while they are enjoying their confection, for a totally pleasurable experience.

No one has to lick the wooden stick of a frozen confection again. No one has to quickly grab a frozen confection stick away from a small child worrying that he or she may be injured. No one has to “eat around the stick” anymore if they would rather not. Edible supports for comestibles and supported comestibles solve these problems. Supports need not be dangerous, taste unpleasant or needlessly add to environmental waste.

My invention is a considerable advancement in the enjoyment of food and can be done so inexpensively and with less damage to children and the world we live in. It can delight people of all ages, customs and cultures, because these edible supports can be made in almost any size, shape, or motif and used with many comestibles.

These new supported comestibles are a unique and safe improvement to frozen and non-frozen confections and comestibles for everyone. They are a lot of fun to eat and are doubly enjoyed. New, edible, supported comestibles add to the festivities and memories of people's special occasions, such as birthdays, summertime, and the happy times of childhood.

While specific embodiments have been illustrated and discussed, these should not be construed as limitations on the scope of the invention, but rather as an exemplification of one preferred embodiment thereof. Many other variations are possible.

For example, any chocolate covered, durable candy bars may be used as edible comestible supports, such as the ones sold by many candy companies. Cookie bars such as the one sold under the trademark Twix by Mars Incorporated of Hackettstown, N.J., can be made more durable by adding another layer of caramel, or other strong ingredient, to the bottom of the long cookie within the cookie bar, as well as the layer of caramel that is supplied to the top. Different shaped packaging boxes, such as a pony shaped box can be used to represent a pony shaped confection inside. Many popular flavor combinations of the edible support and the supported confection can be used, from two or more companies, such as an edible support being made from a candy bar sold under the trademark Milky Way Bar of Mars, Incorporated of Hackettstown, N.J., that supports a peanut butter ice cream sold under the combined trademarks of Good Humor—Breyers Company of Green Bay, Wis. and Reeses Peanut Butter Cup Ice Cream of Hershey Foods Corporation of Hershey, Pennsylvania. A mint cookie flavor ice cream sold under the trademark of the Good Humor—Breyers Corporation can be combined with elongated mint cookies of the Girl Scouts of America.

My edible supported confections can portray famous cartoon characters. Frozen and non-frozen confections can include candy characters on or in the confection, such as in an alcove in the supported confection as well as on or in the edible stick.

Many regular and sandwich cookies, coated with chocolate, white chocolate, dried yogurt, etc., such as the ones sold under the trademark E. L. Fudge Cookies sold by the Keebler Company of Elmhurst, Ill. may be used as supports, as well as candy coated cookie bars such as Twix and Kit Kat. My moisture proof coating, barrier, sealant, mixed with nuts, crushed nuts, crisped rice, cookie crumbs, etc., is also used to coat a supported confection, layers of a supported confection and/or an edible support if desired.

Edible supports are designed to be in any shape such as a “U” shape “x,” “O” shape or any other. Twin supports can be attached by an edible bridge which can be broken to share.

Frozen and non-frozen confections can take on any shape (two or three dimensions), or colors, such as a non-frozen Cinderella's Coach cupcake on an edible chassis with edible wheels, and many colors, sprinkles or sparkles (such as cake confetti or edible cake glitter). Comestible kits may contain instructions for alternate use of the molds and ingredients within the kit.

Kits for the construction of frozen comestibles may be sold in retail stores. A candy bar support(s) may be included with a vacuum packed individual portion(s) of pudding in a desired shape, which is to be constructed and put in the freezer at home. For example, such a combination is a granola bar sold under the trademark Kudos Granola Bar by Mars, Incorporated, inserted in an individual portion of pudding sold under the trademark Hunts Snack Pack Pudding by Hunt-Wesson, Inc of Fullerton, Calif. The Kudos Granola Bar is unwrapped and inserted in the cup of Hunts Snack Pack Pudding and placed in the freezer. When it is frozen, the pop is taken out of the cup and enjoyed. Different shapes of pudding cups, and a longer granola bar may be used, etc.

Support 60 can be combined and surrounded with the ingredients of composite support 62 for a very strong edible support and a triple treat (including the frozen confection), or the ingredients may be reversed. Support 60 includes unique designs, such as it serving as the chassis and wheels for a car comestible. Support 60 may have a large void in the center, so it looks like an elongated “o” and provides two handles to the user. Support 60 is adapted to be manufactured in any shape, size and thickness. Support 60 can have any configuration as needed to support and display edible supported comestibles. Support 60 may also be made in layers of different flavors and colors and have different orientations. Additional fun ingredients 100 may be attached or embedded. A confection that is worn on a finger is adaptable to be worn on two or more fingers.

A composite support may have a core of ice cream, gum, an edible or inedible toy if desired, or solely have ice cream (etc.) in its core and not on its exterior. This cored confection can be large to serve as a treat. An edible support can be part non-edible. It may have a lower portion (or other place) that is made of wood, plastic, paper, or the like. A non-edible designed molded (or other) holder can be made to hold an edible support for keeping the fingers or clothing from getting messy. Any edible support may have an added confection that is embedded in the top portion of the support and extends up through the supported confection to the top, or through and beyond the tip of the supported confection. Such an example is a whimsical frog-like confection with a very long edible tongue, that extends beyond the frozen confection. A composite support may be any size, shape, thickness or ingredients.

Multi-flavored confections 84A are also adapted to be layered, swirled, or twisted and integrated with other ingredients. Ingredients such as ice cream and brownies and cookies may be layered, twisted together or mixed, such as a cookies and creme mixture, ice cream and brownie chunk mixture, or ice cream and candy pieces. Shoe-lace licorice may be integrated and twisted along with an elongated ice cream and sherbert confection, with swirls of different colors and flavors. The outside of confection 84A can be dipped in coating 86 or a coating of sherbert, raspberry puree, clear ice, etc., as well for extra flavor. Shoelace licorice (or other) may also coat the outside of an edible confection by wrapping it in a long spiral around the outside of the confection, edible support or both.

A malleable support that has a hollow center, can be filled with another confection. A more fluid or jell-type confection may be placed inside the hollow center or another edible support or comestible for a burst of flavor. A smaller rope of licorice, such as shoelace licorice, may be placed in this hollow elongated center. Tiny candy beads, or flavored and colored sugar, etc., may also be placed in the long, hollow center of a malleable support. An assortment of different kinds of edible supported comestibles may be sold as a “variety pack.” Supported frozen comestibles can be dipped in fruit puree.

Accordingly, the scope of the invention should be determined not by the embodiments illustrated, but by the appended claims and their legal equivalents.

I claim:

1. A supported comestible comprising:
(a) a comestible comprising a body of an edible substance, and
(b) an edible support suitable for supporting said comestible, said edible support having a first portion extending into said comestible, said first portion having sufficient surface area and means for adherence within said comestible to dependably support said comestible, said edible support having a second portion extending outside said comestible, said second portion having sufficient surface area for providing a utilitarian support for said comestible.

2. The supported comestible of claim 1, further including a sufficient surface area on said second portion extending outside said comestible, so that a person can hold said edible support and said comestible with a hand.

3. The supported comestible of claim 1 wherein said comestible comprising a body of an edible substance is frozen.

4. The supported comestible of claim of 1 wherein said edible support is non-malleable.

5. The supported comestible of claim of 1 wherein said edible support is a cookie.

6. The supported comestible of claim of 1 wherein said edible support is a cookie bar.

7. The supported comestible of claim 1, further including means for providing a supported comestible with an already familiar taste for a consumer, said supported comestible with an already familiar taste for a consumer comprises a) a first dessert comprising a comestible, and b) a long lasting second dessert comprising an edible support, said supported comestible with an already familiar taste for a consumer comprises ingredients of a confection manufacturer, provides a familiar taste for a consumer, and is arranged to comprise a plurality of ingredients, configurations, orientations and designs, said designs includes whimsical designs, said supported comestible with an already familiar taste for a consumer is arranged to comprise a void.

8. The supported comestible of claim 1, further including a lollipop in said supported comestible, said lollipop is arranged to comprise a confection, said confection includes chewing gum, said lollipop is arranged to comprise candy.

9. The supported comestible of claim 1 wherein said edible support is a composite support having a plurality of ingredients, said plurality of ingredients comprises means for a) making said composite support stronger and less prone to breakage, and b) inhibiting the horizontal breaking of said composite support, said composite support is arranged to provide a triple treat comprising a) a comestible of an edible substance, b) a combined homogenous and composite support for providing a very strong edible support and a triple treat, said composite support is arranged to comprise a moisture-proof barrier, said composite support is arranged to comprise a void, said composite support is arranged to comprise a plurality of configurations, orientations and designs, said designs includes whimsical designs.

10. The edible support of claim 1 wherein said edible support comprises a homogeneous composition, said homogenous support is arranged to comprise a void, said homogenous support is arranged to comprise a plurality of colors, flavors, textures, configurations, orientations and designs, wherein said homogenous support is a cookie.

11. The supported comestible of claim 1, further including a plurality of cookies situated on the front and back surfaces of said comestible, for providing a supported sandwiched comestible, said supported sandwiched comestible is arranged to comprise an edible coating.

12. The supported comestible of claim 1, further including a moisture-proof barrier on said comestible and said edible support, said moisture-proof barrier is arranged to comprise a) means for preventing the transfer of moisture from said comestible to said edible support, b) means for providing a secure hold of said comestible to said edible support for consumption of said supported comestible, c) means for providing a long shelf life for said supported comestible, d) means for separating a plurality of comestibles from each other on said edible support, e) means for providing additional flavor and enjoyment on said edible support, said moisture-proof barrier is arrange to comprise a) texture for providing extra adherence of said comestible to said edible support, and b) a light crunch texture on said comestible and said plurality of comestibles.

13. The supported comestible of claim 1, further including an edible coating, on said edible support and said comestible, said edible coating provides additional flavor to said supported comestible, wherein said edible coating comprises sherbert, said edible coating is arranged to separate a plurality of comestibles on said edible support.

14. The supported comestible of claim 1, further including a protective mess guard on said supported comestible, said protective mess guard provides a physical barrier for effectively keeping fingers from melting ingredients on said supported comestible and from getting messy, wherein said protective mess guard comprises texture for a better grip of said supported comestible by a consumer, wherein said protective mess guard is an edible mess guard.

15. The supported comestible of claim 1, further including a protective drip guard on said supported comestible, said protective drip guard catches melting portions of said comestible for preventing a mess on fingers and clothing, wherein said protective drip guard is an edible drip guard.

16. The supported comestible of claim 1, further including means for administering medicine provided in said supported comestible.

17. The supported comestible of claim 1, further including a plurality of edible supports for supporting said comestible, said plurality of edible supports each having a first portion extending into said comestible, said each first portion having sufficient surface area and means for adherence within said comestible to support said comestible, said plurality of edible supports each having a second portion extending outside of said comestible having sufficient surface area for providing a utilitarian support for said comestible.

18. The supported comestible of claim 1, further including a plurality of comestibles on said edible support, said plurality of comestibles are arranged to comprise a plurality of colors, flavors, and ingredients and differ from each other.

19. The supported comestible of claim 1, further including an additional fun ingredient on said comestible and said edible support, said additional fun ingredient adds flavor and enjoyment, said additional fun ingredient is arranged to provide increased surface area for securing said comestible to said edible support for consumption of said supported comestible, said additional fun ingredient comprises a confection, said confection includes chewing gum.

20. The supported comestible of claim 1, further including means for displaying said supported comestible, said means for displaying includes means for enabling said supported comestible to stand upright and on its own on a flat surface.

21. A supported comestible comprising:
(a) a comestible comprising a body of an edible substance, and
(b) an edible composite support comprising a plurality of ingredients suitable for supporting said comestible, said edible composite support having a first portion extending into said comestible, said first portion having sufficient surface area and means for adherence within said comestible to support said comestible, said edible support having a second portion extending outside said comestible, said second portion having sufficient surface area outside said comestible so that a person can hold said support and said comestible with a hand, said plurality of ingredients comprises a) means for making said composite support stronger and less prone to breakage, and b) means for inhibiting the horizontal breaking of said composite support, said composite support comprises a moisture-proof barrier, said composite support is arranged to comprise a plurality of flavors, colors, configurations and orientations, said composite support is arranged to comprise a void.

22. The supported comestible of claim of 21 wherein said comestible comprising a body of an edible substance is frozen.

23. The supported comestible of claim of 21 wherein said edible composite support is non-malleable.

24. The supported comestible of claim of 21 wherein said edible composite support comprises a cookie.

25. The supported comestible of claim of 21 wherein said edible composite support is a cookie bar.

26. A supported comestible comprising:
(a) a comestible comprising a body of an edible substance, and
(b) an edible support suitable for supporting said comestible, said edible support comprises a homogeneous composition, said edible homogenous support having a first portion extending into said comestible, said first portion having sufficient surface area and means for adherence within said confection to dependably support said comestible, said edible support having a second portion extending outside said confection, said second portion having a sufficient size outside said comestible for providing a utilitarian support for said comestible, said edible support is arranged to comprise a plurality of ingredients, colors, flavors, configurations, orientations and designs, said edible support is arranged to comprise a void.

27. The supported comestible of claim of 26 wherein said comestible comprising a body of an edible substance is frozen.

28. The supported comestible of claim of 26 wherein said edible homogenous support is non-malleable.

29. The supported comestible of claim 26 wherein said edible homogenous support is a cookie.

30. An edible support for use in supporting a frozen comestible comprising a body of a edible substance suitable for supporting said frozen comestible, said edible support having a first portion for extending into said frozen comestible, said first portion having a sufficient surface area and means for adherence within said frozen comestible to dependably support said frozen comestible, said edible support having a second portion for extending outside said frozen comestible, said second portion having a sufficient size outside said frozen comestible for providing a utilitarian support for said frozen comestible, said edible support is arranged to comprise a void, said edible support is arranged to comprise a plurality of ingredients, colors, flavors, configurations, orientations and designs, said frozen comestible is arranged to provide a first dessert for a consumer, said edible support is arranged to provide a second dessert for said consumer, whereby said edible support provides a long lasting, totally edible support for a frozen comestible.

31. The edible support for use in supporting a frozen comestible of claim 30 wherein said edible support is a non-malleable support.

32. The edible support for use in supporting a frozen comestible of claim 30 wherein said edible support is a cookie.

33. The edible support for use in supporting a frozen comestible of claim 30 wherein said edible support is a cookie bar.

34. A supported frozen comestible comprising:
(a) a comestible comprising a body of a frozen edible substance,
(b) an edible support suitable for providing a dependable utilitarian support to said comestible, and
(c) means for supporting said comestible, whereby a consumer can enjoy a longer lasting supported frozen comestible that can be entirely eaten.

35. The supported frozen comestible of claim 34 wherein said edible support is a non-malleable support.

36. The supported frozen comestible of claim 34 wherein said edible support is a cookie support.

37. The supported frozen comestible of claim 34, further including means for providing a handle for a consumer for consumption of said supported frozen comestible.

38. The supported frozen comestible of claim 34, further including means for providing a safe supported comestible for children.

39. A method of providing a supported frozen comestible comprising:
(a) providing a comestible comprising a body of an edible substance suitable for freezing,
(b) providing an edible support, said edible support having first and second portions, for supporting said comestible,
(c) inserting said first portion of said edible support, into said comestible, said first portion comprising sufficient surface area and means for adherence inside said comestible to dependably support said comestible,
(d) freezing said comestible and said edible support, and
(e) leaving said second portion, having sufficient surface area outside of said comestible to provide a dependable utilitarian support for said comestible, whereby a consumer can enjoy a long lasting supported frozen comestible, which includes eating the stick.

40. The method of providing a supported frozen comestible of claim 39 wherein said edible support is a non-malleable support.

41. The method of providing a supported frozen comestible of claim 39 wherein said edible support is a cookie support.

42. The method of providing a supported frozen comestible of claim 39, further including means for providing a handle, so that a person can hold said edible support and said frozen comestible with a hand.
